(19) United States
(12) Patent Application Publication
(10) Pub. No.: US 2020/0001240 A1
(43) Pub. Date: Jan. 2, 2020

(54) MEMBRANE SEPARATION DEVICE AND MEMBRANE SEPARATION METHOD

(71) Applicant: MITSUBISHI ELECTRIC CORPORATION, Chiyoda-ku (JP)

(72) Inventors: Yoshifumi HAYASHI, Chiyoda-ku (JP); Wataru YOSHIDA, Chiyoda-ku (JP); Eiji IMAMURA, Chiyoda-ku (JP); Seiji NODA, Chiyoda-ku (JP); Nozomu YASUNAGA, Chiyoda-ku (JP)

(73) Assignee: MITSUBISHI ELECTRIC CORPORATION, Chiyoda-ku (JP)

(21) Appl. No.: 16/481,738

(22) PCT Filed: Nov. 8, 2017
(86) PCT No.: PCT/JP2017/040283

§ 371 Date: Jul. 29, 2019

(30) Foreign Application Priority Data
Mar. 23, 2017 (JP) 2017-057090

(51) Int. Cl. B01D 65/02; B01D 61/00; C02F 1/44; C02F 1/00

(52) U.S. Cl. CPC B01D 65/02; B01D 61/00; C02F 1/44; C02F 1/008; B01D 2311/14; B01D 2311/246; C02F 3/1273; B01D 2315/06; C02F 2209/40; C02F 2209/03; C02F 2209/38; C02F 2303/16; B01D 2321/185

(57) ABSTRACT

This membrane separation device includes: an organic substance concentration measurement means which measures the organic substance concentration in the treatment target water; a pressure measurement unit which measures a transmembrane pressure of the separation membrane; transmembrane pressure increase speed comparing means which compares a transmembrane pressure increase speed selected on the basis of the value of the organic substance concentration measured by the organic substance concentration measurement means, with a transmembrane pressure increase speed calculated from the transmembrane pressure measured by the pressure measurement unit; and a control unit which controls the membrane surface aeration flow amount of the membrane surface aeration device, wherein the control unit changes the membrane surface aeration flow amount on the basis of the difference between the transmembrane pressure increase speeds, obtained by the transmembrane pressure increase speed comparing means.

### TECHNICAL FIELD

The present invention relates to a membrane separation device and a membrane separation method in which, while air is diffused toward a separation membrane provided so as to be immersed in drained water containing organic substances, treated water that has passed through the separation membrane is obtained.

### BACKGROUND ART

As a method for treating drained water containing organic substances (hereinafter, referred to as “treatment target water”), a membrane bioreactor (MBR) is used in which organic substances in treatment target water are decomposed using microorganisms and the treatment target water is filtered by a separation membrane to be separated into solid and liquid. In filtering using the separation membrane, as the separation membrane continues to be used, contaminants adhere to the surface of the separation membrane or into the pores of the separation membrane and thus clogging may occur, whereby filtering performance gradually deteriorates.

Therefore, the following method is used: a diffuser device is provided below the separation membrane, aeration with air or the like is performed toward the separation membrane from the diffuser device, the adhering materials on the separation membrane surface are peeled by bubbles and ascending flow of the treatment target water, thereby suppressing clogging. The energy cost required for this aeration is calculated to reach approximately half the entire operation cost. Accordingly, various techniques for suppressing the aeration amount are being developed.

Patent Document 1 proposes a method in which the transmembrane pressure (TMP) of a filtration membrane is measured and the aeration flow amount is controlled so that the transmembrane pressure is maintained at a predetermined increase speed set in advance. Specifically, a reference value for the transmembrane pressure is updated and set so as to automatically increase every certain period, the next target value for the aeration flow amount is set on the basis of a difference value between the reference value and a measurement value of the transmembrane pressure for each time, and the aeration flow amount is controlled in accordance with the target value.

Patent Document 2 proposes that a negative operation pressure difference inside a flat membrane unit is measured by a pressure meter, and the amount of diffused air from a diffuser device and an intermittent operation time ratio of operation and stop of a suction pump are controlled on the basis of the rate of change in the increase speed of the operation pressure difference. In addition, an optimum pattern for the diffused air amount and the intermittent operation time ratio is estimated, and automatic control is performed on the basis of the estimation.

### CITATION LIST

### Patent Document

Patent Document 1: Japanese Laid-Open Patent Publication No. 2013-202472
Patent Document 2: Japanese Laid-Open Patent Publication No. 2000-300968

### SUMMARY OF THE INVENTION

### Problems to be Solved by the Invention

However, in the method of controlling the aeration flow amount on the basis of the transmembrane pressure (hereinafter, may be referred to as TMP) of the filtration membrane as shown in the above Patent Documents 1, 2, the water quality of the treatment target water to be subjected to solid/liquid separation by the separation membrane is not measured, and therefore an excessive aeration flow amount is sometimes needed for maintaining the aeration flow amount at the target value therefor. Thus, under such a condition, there is a possibility that an excessive aeration flow amount is required.

The present invention has been made to solve the above problem, and an object of the present invention is to obtain a membrane separation device and a membrane separation method that enable reduction of operation cost by reducing a membrane surface aeration flow amount.

### Solution to the Problems

A membrane separation device according to the present invention includes: a separation membrane which filters treatment target water in a membrane separation tank; a membrane surface aeration device which supplies air for performing membrane surface aeration for the separation membrane; organic substance concentration measurement means which measures an organic substance concentration in the treatment target water; a pressure measurement unit which measures a transmembrane pressure of the separation membrane; transmembrane pressure increase speed comparing means which compares a transmembrane pressure increase speed R_{T} selected on the basis of a value of the organic substance concentration measured by the organic substance concentration measurement means, with a transmembrane pressure increase speed R_{M} calculated from the transmembrane pressure measured by the pressure measurement unit; and a control unit which controls a membrane surface aeration flow amount of the membrane surface aeration device, wherein the control unit changes the membrane surface aeration flow amount on the basis of the difference, obtained by the transmembrane pressure increase speed comparing means, between the transmembrane pressure increase speed R_{T} selected on the basis of the value of the organic substance concentration measured by the organic substance concentration measurement means and the transmembrane pressure increase speed R_{M} calculated from the transmembrane pressure measured by the pressure measurement unit.

Another membrane separation device according to the present invention includes: a separation membrane which filters treatment target water in a membrane separation tank; a membrane surface aeration device which supplies air for performing membrane surface aeration for the separation membrane; first organic substance concentration measurement means which measures an organic substance concentration in the treatment target water; second organic substance concentration measurement means which measures an organic substance concentration in filtered water filtered by the separation membrane; a pressure measurement unit which measures a transmembrane pressure of the separation membrane; transmembrane pressure increase speed comparing means which compares a transmembrane pressure increase speed R_{T} selected on the basis of an organic substance concentration difference obtained by subtracting a value of the organic substance concentration measured by the second organic substance concentration measurement means from a value of the organic substance concentration measured by the first organic substance concentration measurement means, with a transmembrane pressure increase speed R_{M} calculated from the transmembrane pressure measured by the pressure measurement unit; and a control unit which controls a membrane surface aeration flow amount of the membrane surface aeration device, wherein the control unit changes the membrane surface aeration flow amount on the basis of the difference, obtained by the transmembrane pressure increase speed comparing means, between the transmembrane pressure increase speed R_{T} selected on the basis of the value of the organic substance concentration measured by the organic substance concentration measurement means and the transmembrane pressure increase speed R calculated from the transmembrane pressure measured by the pressure measurement unit.

A membrane separation method according to the present invention includes: filtering a treatment target water in a membrane separation tank by a separation membrane; measuring an organic substance concentration in the treatment target water when performing membrane surface aeration for supplying bubbles by a diffuser pipe from below the separation membrane; selecting a transmembrane pressure increase speed as a target on the basis of a measured value of the organic substance concentration; comparing the target transmembrane pressure increase speed with an increase speed of a transmembrane pressure of the separation membrane; and setting a flow amount of the membrane surface aeration so that a difference between the transmembrane pressure increase speed and the increase speed becomes small.

### Effect of the Invention

The present invention changes the TMP increase speed by changing the membrane surface aeration flow amount on the basis of the concentration of organic substances contained in the treatment target water in the membrane separation tank, thereby enabling reduction of operation cost required for aeration and thus providing a significant effect that has not been achieved conventionally.

### BRIEF DESCRIPTION OF THE DRAWINGS

FIG. 1 is a configuration diagram of a membrane separation device according to embodiment 1 of the present invention.

FIG. 2 illustrates organic substance concentration measurement means used in the membrane separation device in embodiment 1 of the present invention.

FIG. 3 shows the relationship among a TMP increase speed, a membrane surface aeration flow amount, and an organic substance concentration.

FIG. 4 illustrates a membrane surface aeration flow amount and a target TMP increase speed set without depending on an organic substance concentration.

FIG. 5 illustrates a membrane surface aeration flow amount and a target TMP increase speed set on the basis of an organic substance concentration.

FIG. 6 illustrates a target TMP increase speed setting method in embodiment 1 of the present invention.

FIG. 7 is a flowchart of a control procedure for the membrane surface aeration flow amount in embodiment 1 of the present invention.

FIG. 8 is a configuration diagram of a membrane separation device according to embodiment 2 of the present invention.

FIG. 9 shows the relationship among a TMP increase speed, a membrane surface aeration flow amount, and an organic substance concentration when an inflection point is changed.

FIG. 10 is a configuration diagram of database update means in embodiment 2 of the present invention.

FIG. 11 illustrates a database update method in embodiment 2 of the present invention.

FIG. 12 illustrates a database update method in embodiment 2 of the present invention.

FIG. 13 is a flowchart of an adjustment procedure for a membrane surface aeration flow amount in embodiment 2 of the present invention.

FIG. 14 is a flowchart of a database update procedure in embodiment 2 of the present invention.

FIG. 15 is a configuration diagram of a membrane separation device according to embodiment 3 of the present invention.

FIG. 16 illustrates organic substance concentration measurement means used in a membrane separation device in embodiment 4 of the present invention.

FIG. 17 illustrates target TMP increase speed setting means used in a membrane separation device in embodiment 5 of the present invention.

FIG. 18A shows a database indicating the relationship among a membrane surface aeration flow amount, a TMP increase speed, and an ultraviolet absorbance.

FIG. 18B shows a database indicating the relationship among a membrane surface aeration flow amount, a TMP increase speed, and a water temperature.

FIG. 18C shows a database indicating the relationship among a membrane surface aeration flow amount, a TMP increase speed, and a suspended solid in mixed liquor in an aeration tank.

FIG. 18D shows a database indicating the relationship among a membrane surface aeration flow amount, a TMP increase speed, and a filtration flux.

FIG. 19 illustrates target TMP increase speed setting means used in a membrane separation device in embodiment 6 of the present invention.

FIG. 20 shows a membrane separation device in Example 1, Example 2, and a comparative example.

FIG. 21 illustrates a membrane separation device in the comparative example.

FIG. 22 illustrates a database in Example 1.

FIG. 23 illustrates a database in Example 2.

FIG. 24 shows an example of hardware of TMP increase speed changing means in embodiment 1 and other embodiments of the present invention.

### DESCRIPTION OF EMBODIMENTS

### Embodiment 1

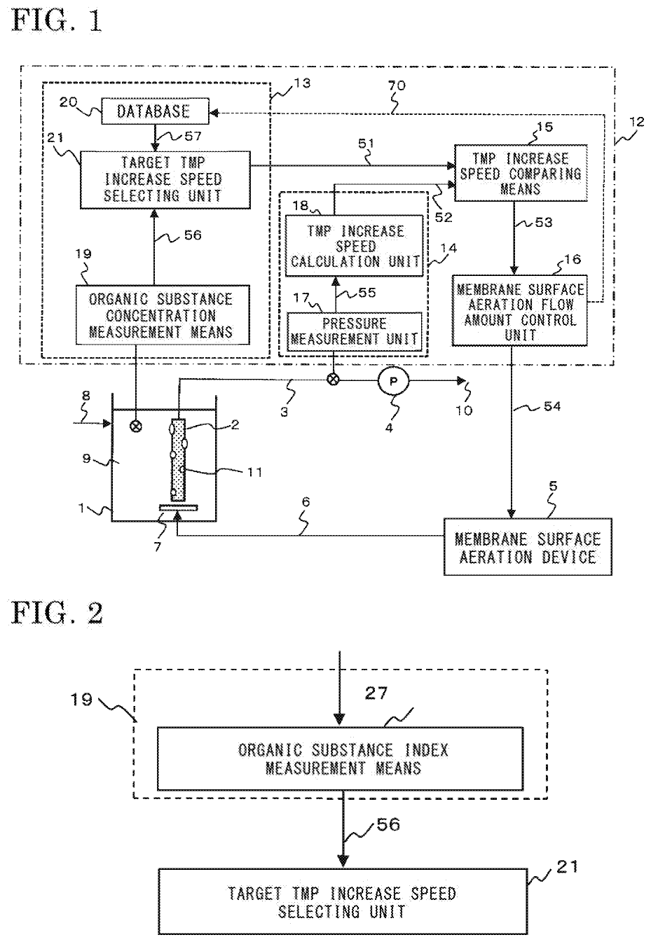

Hereinafter, a membrane separation device according to embodiment 1 of the present invention will be described with reference to FIG. 1 to FIG. 7. FIG. 1 is a configuration diagram of the membrane separation device, and FIG. 2 illustrates organic substance concentration measurement means used in the membrane separation device.

As shown in FIG. 1, the membrane separation device according to the present invention includes: a membrane separation tank 1 which stores treatment target water 9; a separation membrane 2 provided so as to be immersed in the membrane separation tank 1; a filtered water pipe 3 through which treated water 10 obtained by the treatment target water 9 being filtered by the separation membrane 2 passes; a filtration pump 4 for discharging the treated water 10; a membrane surface aeration device 5 which supplies air for peeling contaminants adhering to the separation membrane 2; an aeration pipe 6 through which air supplied from the membrane surface aeration device 5 passes; a diffuser pipe 7 which supplies bubbles 11 flowing from the lower side to the upper side of the separation membrane 2 by using the air from the aeration pipe 6; and transmembrane pressure increase speed changing means (hereinafter, referred to as TMP increase speed changing means) 12 which changes a transmembrane pressure (TMP) increase speed on the basis of the concentration of organic substances contained in the treatment target water 9 in the membrane separation tank 1.

Here, the case where activated sludge is contained in the treatment target water 9 will be described. However, activated sludge does not necessarily need to exist in the treatment target water 9.

Inflow water 8 flows into the membrane separation tank 1, and the filtered water pipe 3 is connected to the membrane separation tank 1 via the separation membrane 2. The membrane separation tank 1 is required to receive the inflow water 8 and store the treatment target water 9, and the material and the structure thereof are required to be ones that prevent water leakage, e.g., concrete, stainless steel, or resin. The separation membrane 2 is required to be means such as a hollow fiber membrane or a flat membrane that is capable of separation into solid and liquid, and is not limited to an RO membrane, an NF membrane, a UF membrane, an MF membrane, or the like. The separation membrane 2 is connected to the filtration pump 4 via the filtered water pipe 3. The separation membrane 2 is immersed in the membrane separation tank 1, and the diffuser pipe 7 is provided directly under the separation membrane 2, at the lower part of the membrane separation tank 1.

The diffuser pipe 7 is required to be capable of supplying bubbles 11, and may be made from glass, stainless steel, sintered metal, resin, or the like. The diffuser pipe 7 is connected to the membrane surface aeration device 5 via the aeration pipe 6. The membrane surface aeration device 5 is required to be a device such as a blower that is capable of pressure-feeding air. Organic substance concentration measurement means 19 is provided for the treatment target water 9 in the membrane separation tank 1. The organic substance concentration measurement means 19 is required to be means such as a total organic carbon concentration meter, an ultraviolet absorbance meter, or a fluorescence intensity meter, that is capable of directly or indirectly measuring organic substances in water. An organic substance concentration sensor such as a total organic carbon concentration meter, an ultraviolet absorbance meter, or a fluorescence intensity meter may be immersed in the membrane separation tank 1, to perform measurement, or the treatment target water 9 in the membrane separation tank 1 may be supplied to the organic substance concentration sensor, to perform measurement.

A pressure measurement unit 17 is provided to the filtered water pipe 3 between the separation membrane 2 and the filtration pump 4. The pressure measurement unit 17 is a meter that is capable of measuring a pressure, and may be either a digital type or an analog type. Preferably, the pressure measurement unit 17 is provided with a mechanism that can store pressure values measured over time. The organic substance concentration measurement means 19 and the pressure measurement unit 17 are included in the TMP increase speed changing means 12, and the TMP increase speed changing means 12 is connected to the membrane surface aeration device 5 via a signal line 54.

Next, the configuration of the TMP increase speed changing means 12 will be described. The TMP increase speed changing means 12 includes target TMP increase speed setting means 13, TMP increase speed measurement means 14, TMP increase speed comparing means 15, and membrane surface aeration flow amount control unit 16. The membrane surface aeration flow amount control unit 16 is connected to a database 20 described later via a signal line 70.

The target TMP increase speed setting means 13 includes the organic substance concentration measurement means 19, the database 20, and a target TMP increase speed selecting unit 21. The organic substance concentration measurement means 19 and the target TMP increase speed selecting unit 21 are connected via a signal line 56, and the database 20 and the target TMP increase speed selecting unit 21 are connected via a signal line 57. The target TMP increase speed selecting unit 21 is connected to the TMP increase speed comparing means 15 via a signal line 51.

In the database 20, water quality, temporal changes in TMP, and the like acquired by the past water treatments are recorded and stored as a database. The target TMP increase speed selecting unit 21 compares the data stored in the database 20 and data acquired by the organic substance concentration measurement means 19, and selects a target TMP increase speed R_{T}. Preferably, the target TMP increase speed R_{T} is 0.01 to 40 kPa/h.

As shown in FIG. 2, the organic substance concentration measurement means 19 includes organic substance index measurement means 27 for measuring at least one organic substance index of UV (ultraviolet absorbance), TOC (total organic carbon), COD (chemical oxygen demand), BOD (biochemical oxygen demand), a humic acid concentration, a sugar concentration, and a protein concentration.

By supplying the treatment target water 9 in the membrane separation tank 1 to the organic substance index measurement means 27, it is possible to measure at least one organic substance index of UV, TOC, COD, BOD, a humic acid concentration, a sugar concentration, and a protein concentration. It has been confirmed that the substances corresponding to these indexes are readily captured by the separation membrane 2 and can be used as indexes for clogging, whereby organic substances that can cause clogging in the membrane can be accurately measured.

Here, the present invention is implemented under the condition that the UV value is 0 to 10 Abs/cm, the TOC value is 1 to 500 mg/L, the COD value and the BOD value are 1 to 500 mg/L, and the humic acid concentration, the sugar concentration, and the protein concentration are 0 to 500 mg/L.

The TMP increase speed measurement means 14 includes the pressure measurement unit 17 and a TMP increase speed calculation unit 18 which are connected via a signal line 55. The TMP increase speed calculation unit 18 is connected to the TMP increase speed comparing means 15 via a signal line 52. The TMP increase speed calculation unit 18 calculates the TMP from a pressure measured by the pressure measurement unit 17, and calculates a TMP increase speed R_{M} on the basis of temporal change in the TMP.

The TMP increase speed comparing means 15 is connected to the membrane surface aeration flow amount control unit 16 via a signal line 53. The TMP increase speed comparing means 15 is connected to the target TMP increase speed selecting unit 21 via the signal line 51, and connected to the TMP increase speed calculation unit 18 via the signal line 52. The TMP increase speed comparing means 15 compares the TMP increase speed R_{M} calculated by the TMP increase speed calculation unit 18 and the target TMP increase speed R_{T} selected by the target TMP increase speed selecting unit 21, and sends the difference therebetween to the membrane surface aeration flow amount control unit 16 via the signal line 53.

The membrane surface aeration flow amount control unit 16 controls the membrane surface aeration flow amount of the membrane surface aeration device 5 on the basis of the signal obtained from the TMP increase speed comparing means 15. Further, data used in the control is sent to the database 20 via the signal line 70, and thus data about the membrane surface aeration flow amount is accumulated.

Hereinafter, a procedure of control for the membrane surface aeration flow amount will be described. Aeration is performed with a gas such as air from the diffuser pipe 7 provided below the separation membrane 2, and the adhering materials on the surface of the separation membrane 2 are peeled by bubbles 11 and ascending flow of the treatment target water 9 caused by the bubbles, whereby clogging of the separation membrane 2 is suppressed. The TMP increase speed varies depending on the extent to which clogging is suppressed, and as the membrane surface aeration flow amount increases, clogging becomes less likely to occur. Here, preferably, the membrane surface aeration flow amount per membrane area of the separation membrane 2 is controlled to be 0.01 to 10 m³/hr/(membrane filtration area m²).

The extent of clogging of the separation membrane 2 can be grasped from the value measured by the pressure measurement unit 17. As membrane filtration is continuously performed by the filtration pump 4, the separation membrane 2 is gradually clogged and the TMP increases. This is grasped from data of TMP and time sent from the pressure measurement unit 17 via the signal line 55 at the TMP increase speed calculation unit 18, and the temporal change of the TMP is calculated as the TMP increase speed R_{M}. Preferably, the interval of measurement of TMP for calculating the TMP increase speed is once a second to once a day, and preferably, the TMP increase speed R_{M} is calculated from temporal change in the TMP over a range of one minute to one month. The TMP increase speed R_{M} is sent to the TMP increase speed comparing means 15 via the signal line 52.

Meanwhile, the organic substance concentration measurement means 19 measures the organic substance concentration in the treatment target water 9 over time. The measurement interval may be once a minute to once an hour, or may be once a day. The value of the measured organic substance concentration is sent to the target TMP increase speed selecting unit 21 via the signal line 56. The target TMP increase speed selecting unit 21 selects a target TMP increase speed R_{T} on the basis of the organic substance concentration obtained from the organic substance concentration measurement means 19 and the data in the database 20 in which association between a TMP increase speed and water quality such as organic substance concentration, water temperature, and solid material concentration in the past is stored as data. The selected TMP increase speed R_{T} is sent to the TMP increase speed comparing means 15 via the signal line 51.

The TMP increase speed comparing means 15 compares the TMP increase speed R_{M} calculated by the TMP increase speed calculation unit 18 and the TMP increase speed R_{T} selected by the target TMP increase speed selecting unit 21, and sends the difference therebetween to the membrane surface aeration flow amount control unit 16 via the signal line 53. The membrane surface aeration flow amount control unit 16 sets the value of the membrane surface aeration flow amount so that the difference becomes small or zero, and sends the set value to the membrane surface aeration device 5 via the signal line 54.

In the case where the value of the TMP increase speed R_{M} calculated by the TMP increase speed calculation unit 18 is greater than the TMP increase speed R_{T} selected by the target TMP increase speed selecting unit 21, it is necessary to increase the membrane surface aeration flow amount. On the other hand, in the case where the value of the TMP increase speed R_{M} calculated by the TMP increase speed calculation unit 18 is smaller than the TMP increase speed R_{T} selected by the target TMP increase speed selecting unit 21, it is necessary to decrease the membrane surface aeration flow amount.

The membrane surface aeration device 5 is controlled by an inverter and sends a gas such as air through the aeration pipe 6 to the diffuser pipe 7 so as to achieve the membrane surface aeration flow amount according to the value from the membrane surface aeration flow amount control unit 16, thereby performing membrane surface aeration. The TMP increase speed R_{M} and the organic substance concentration in the treatment target water 9 are measured periodically, and the above operation is repeated. Such data are all sent from the membrane surface aeration flow amount control unit 16 via the signal line 70 to the database 20 and accumulated therein. In the case where the TMP reaches a certain value, e.g., 25 kPa, membrane filtration operation is stopped and the separation membrane 2 is washed. A specific method for determining the value of the aeration flow amount will be described later.

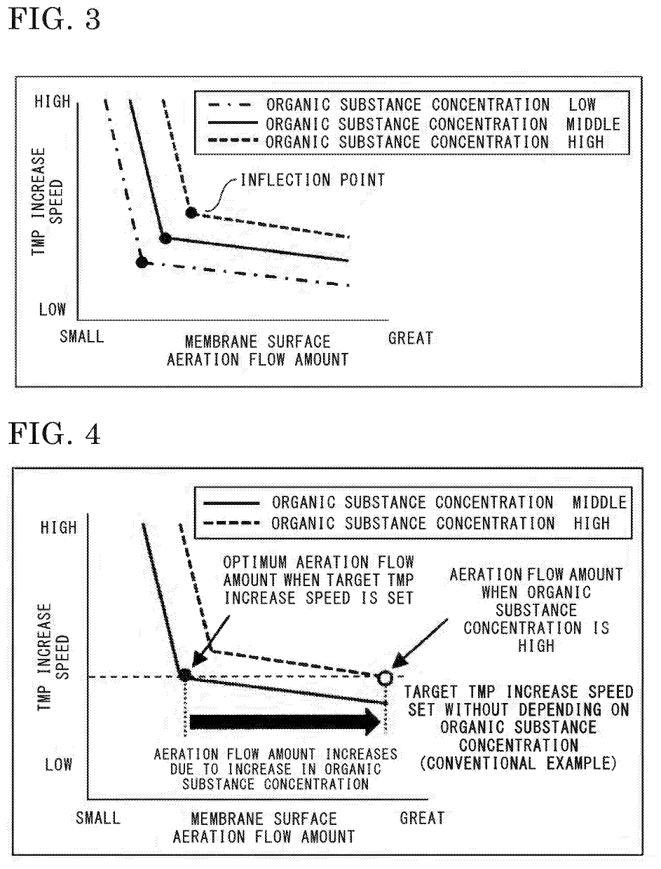

The present inventors have earnestly investigated the relationship among the TMP increase speed, the membrane surface aeration flow amount, and the water quality of treatment target water, and as a result, have found that there is a relationship as shown in FIG. 3 among the TMP increase speed, the membrane surface aeration flow amount, and the water quality of the treatment target water 9 in the membrane separation tank 1, in particular, the concentration of organic substances contained in the treatment target water 9.

As shown in FIG. 3, it has been found that the TMP increase speed sharply increases when the membrane surface aeration flow amount is decreased. Here, a point where the TMP increase speed sharply increases is referred to as an inflection point. If the membrane surface aeration flow amount becomes small, bubbles supplied by membrane surface aeration from the separation membrane surface and flow of the treatment target water 9 caused by the bubbles are reduced, and substances such as microorganisms and contaminants that cannot pass through the separation membrane 2 adhere to the separation membrane surface, thereby hampering membrane filtration, so that the TMP increase speed is likely to increase.

On the other hand, if the membrane surface aeration flow amount becomes great, microorganisms, contaminants, and the like are less likely to adhere to the separation membrane surface, and thus the TMP increase speed can be reduced to be low. Existence of the point where the TMP increase speed sharply increases, i.e., the inflection point, is a discovery, and it is possible to indirectly grasp the condition of adhesion of microorganisms, contaminants, and the like to the separation membrane surface by monitoring the TMP increase speed. Further, from the result at this time, it has been found that increase in the TMP increase speed is caused due to two factors.

That is, the two factors are adhesion of microorganisms, contaminants, and the like to the separation membrane surface and adhesion of organic substances to inside of the separation membrane. Adhesion of microorganisms, contaminants, and the like to the separation membrane surface rapidly causes clogging of the separation membrane surface, and thus contributes to sharp increase in the TMP increase speed where the membrane surface aeration flow amount is at the inflection point or lower. On the other hand, the pace of adhesion of organic substances to the inside of the separation membrane is slow, and thus contributes to gradual change in the TMP increase speed where the membrane surface aeration flow amount is at the inflection point or higher. This discovery is significantly important knowledge for controlling the TMP increase speed.

Further, it has been discovered that: as the organic substance concentration in the treatment target water 9 increases, the membrane surface aeration flow amount needed for reducing the same TMP increase speed increases; as the organic substance concentration in the treatment target water 9 increases, the membrane surface aeration flow amount at the inflection point increases; and, as the organic substance concentration in the treatment target water 9 increases, the TMP increase speed where the membrane surface aeration flow amount is at the inflection point or higher, increases. As the membrane surface aeration flow amount decreases, the amount of microorganisms, contaminants, and the like adhering to the separation membrane surface increases, and also, the thicknesses thereof increase. At this time, organic substances existing in the treatment target water 9 and spaces among microorganisms and contaminants serve as binders, so that the materials adhering on the separation membrane surface become less likely to be peeled from the separation membrane surface by bubbles supplied by membrane surface aeration and flow of the treatment target water 9 by the bubbles. Therefore, if the organic substance concentration in the treatment target water 9 increases, the membrane surface aeration flow amount needed for removing the materials adhering to the separation membrane surface also increases.

In the case of the membrane surface aeration flow amount below the inflection point, the function of the organic substances as a binder is more significant than the function of the organic substances as a binder when the membrane surface aeration flow amount is above the inflection point, and thus the TMP increase speed sharply increases due to the materials adhering to the separation membrane surface. On the other hand, in the case of the membrane surface aeration flow amount above the inflection point, the amount of materials adhering to the separation membrane surface is reduced and thus the contribution thereof to the TMP increase speed becomes small. However, in contrast to this, clogging of the separation membrane progresses due to adhesion of the organic substances to the inside of the separation membrane. From the above, it can be explained that, as the organic substance concentration in the treatment target water 9 increases, the separation membrane becomes more likely to be clogged, the TMP increase speed increases, and the membrane surface aeration flow amount at the inflection point also increases.

Here, preferably, the organic substance concentration is a value obtained with contaminants and turbidity excluded. That is, the organic substance concentration is measured after contaminants and turbidity are excluded through centrifugal separation, filtration, or the like in advance, whereby the relationships of the membrane surface aeration flow amount and the TMP increase speed with respect to each value of the organic substance concentration can be enhanced in accuracy.

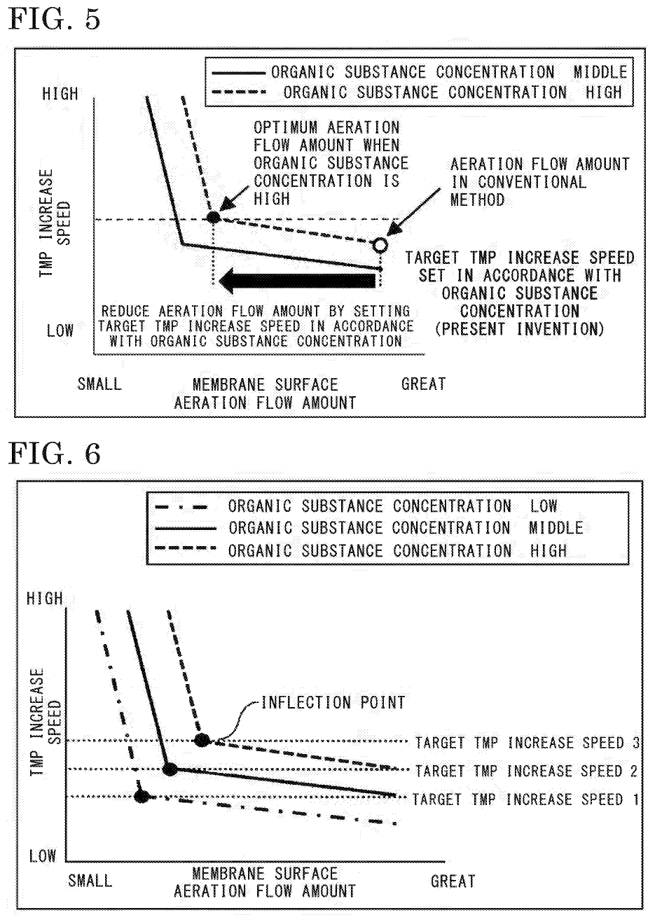

Here, with reference to FIG. 4 and FIG. 5, effects obtained by measuring the organic substance concentration in the treatment target water 9 will be described. In the case where, even though the organic substance concentration in the treatment target water 9 was high, the value thereof was roughly defined as middle because the organic substance concentration was not measured, the membrane surface aeration flow amount was changed so that the TMP increase speed became constant. That is, in the case where the organic substance concentration has increased from middle to high, if operation is continued with the aeration flow amount at the inflection point for the case where the organic substance concentration is middle, the TMP increase speed increases. Accordingly, the membrane surface aeration flow amount is increased so that the TMP increase speed becomes constant (FIG. 4), and as a result, also the inflection point of the membrane surface aeration flow amount for the case where the organic substance concentration is middle actually becomes a greatly increased value (FIG. 5), and thus energy consumption increases.

That is, by measuring the organic substance concentration in the treatment target water 9 and setting the membrane surface aeration flow amount on the basis thereof, it becomes possible to greatly reduce the membrane surface aeration flow amount, though the TMP increase speed slightly increases. The energy cost required for membrane surface aeration is significantly large as compared to the operation cost for washing or the like. Therefore, even if the frequency of washing increases due to the slight increase in the TMP increase speed as shown in FIGS. 4 and 5, the operation cost in the entire system can be reduced by this method.

Hereinafter, with reference to FIG. 6, a method for calculating the membrane surface aeration flow amount from a target TMP increase speed corresponding to the measurement value of the organic substance concentration, will be described. FIG. 6 is a graph collectively showing the relationships between the membrane surface aeration flow amount and the TMP increase speed for the respective cases where the organic substance concentration is high, middle, and low, and this is a database obtained through operation of the membrane separation device shown in FIG. 1. As described above, these data are composed of values obtained from the pressure measurement unit 17 and the organic substance concentration measurement means 19, and values obtained from the membrane surface aeration flow amount of the membrane surface aeration device 5.

The inflow water 8 varies from moment to moment, and along with this, the organic substance concentration in the treatment target water 9 varies depending on the operation conditions such as a solid retention time (SRT) in the membrane separation device and the dissolved oxygen concentration in the treatment target water 9. In accordance with whether the organic substance concentration is high, middle, or low, the target TMP increase speed R_{T}, i.e., the membrane surface aeration flow amount Q_{T} at the inflection point in FIG. 6, is set, whereby the energy cost required for membrane surface aeration of the membrane separation device can be maintained at a minimum level.

High, middle, and low organic substance concentrations can be represented by using, for example, the absorbance of an ultraviolet ray having a wavelength of 220 to 270 nm, as follows. High: 2.000 Abs/cm or greater, middle: 0.001 to 1.999 Abs/cm or greater, low: 0.000 to 0.001 Abs/cm. Regarding a wavelength for ultraviolet absorbance measurement, 254 nm or 260 nm may be used as a first preferential candidate. The membrane surface aeration flow amount is set in a range of 0.01 m³/hr/m² to 10 m³/hr/m². The filtration area per one bar or one sheet of the separation membrane 2 is 0.01 to 100 m².

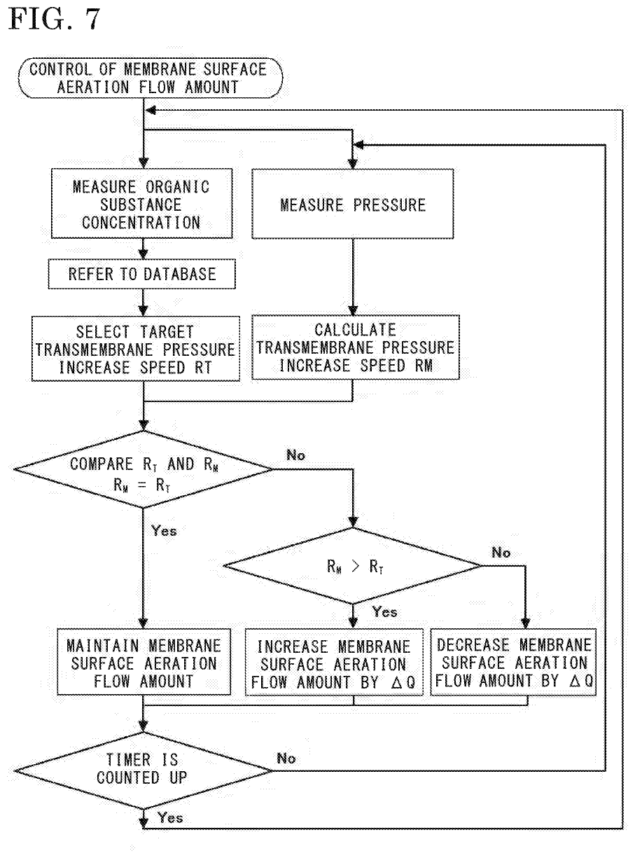

FIG. 7 shows a flowchart of a control procedure for the membrane surface aeration flow amount in embodiment 1.

The organic substance concentration measurement means 19 measures the organic substance concentration in the treatment target water 9. The target TMP increase speed selecting unit 21 selects the target TMP increase speed R_{T} based on the measured organic substance concentration from the data in the database 20. In addition, the pressure measurement unit 17 measures the TMP, and the TMP increase speed calculation unit 18 calculates the TMP increase speed R_{M} from the TMP measured by the pressure measurement unit. Next, the TMP increase speed R_{M} calculated by the TMP increase speed calculation unit 18 and the target TMP increase speed R_{T} selected by the target TMP increase speed selecting unit 21 are compared with each other.

If the TMP increase speed R_{M} is equal to the target TMP increase speed R_{T} or the absolute value of a difference between the TMP increase speed R_{M} and the target TMP increase speed R_{T} is smaller than an optionally set value a, the membrane surface aeration flow amount is maintained. If the TMP increase speed R_{M} is greater than the target TMP increase speed R_{T} or the TMP increase speed R_{N} is greater than the target TMP increase speed R_{T} by the optionally set value a or greater, the membrane surface aeration flow amount is increased by ΔQ. If the TMP increase speed R_{M} is smaller than the target TMP increase speed R_{T} or the TMP increase speed R_{M} is smaller than the target TMP increase speed R_{T} by the optionally set value a or greater, the membrane surface aeration flow amount is decreased by ΔQ. The optionally set value a can be optionally set in consideration of measurement error of the transmembrane pressure increase speed and convenience for operation in flow amount control. The change amount ΔQ for the membrane surface aeration flow amount can be optionally set, and may be set on the basis of a difference between the TMP increase speed R_{M} and the target TMP increase speed R_{T} or the change rate of the TMP increase speed R_{M}, or may be set on the basis of the organic substance concentration or the amount of change in the organic substance concentration.

After the membrane surface aeration flow amount is maintained or increased/decreased, the TMP increase speed R_{M} is calculated again. Further, the TMP increase speed R_{M} and the target TMP increase speed R_{T} are compared with each other, and the membrane surface aeration flow amount is adjusted by the method described above. Such a procedure is repeated until reaching to a step of measuring the next organic substance concentration. Thus, the value of the membrane surface aeration flow amount is set so that the TMP increase speed R_{M} is controlled to be equal to the target TMP increase speed R_{T} or the absolute value of the difference therebetween is controlled to be smaller than the optionally set value a. If the step of measuring the next organic substance concentration is reached, the organic substance concentration is measured and the above process is repeated.

As described above, in the invention according to embodiment 1, the target TMP increase speed R_{T} is set on the basis of the concentration of organic substances contained in the treatment target water 9, and the membrane surface aeration flow amount is controlled so that the TMP increase speed is maintained at the target TMP increase speed R_{T}. Therefore, it is possible to reduce the membrane surface aeration flow amount and reduce the operation cost for the entire device.

### Embodiment 2

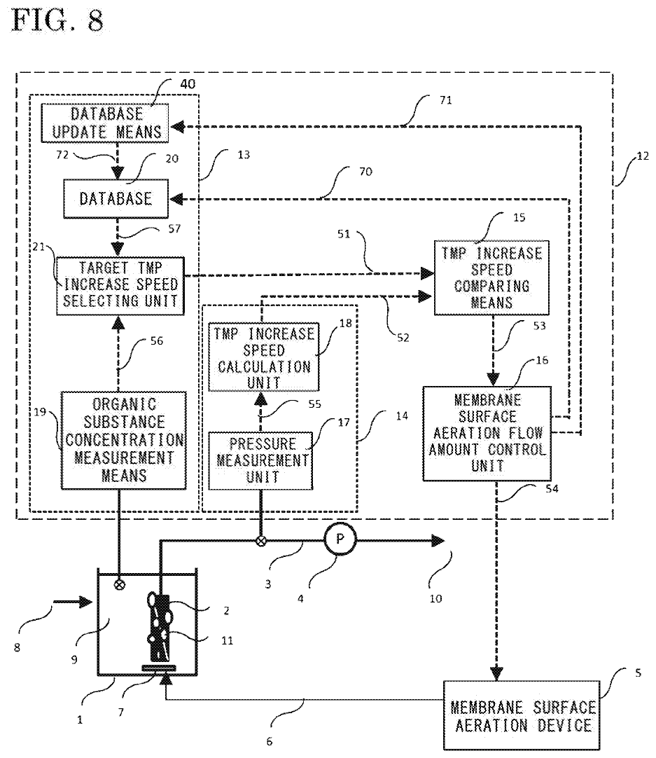

Next, a membrane separation device according to embodiment 2 of the present invention will be described with reference to FIG. 8. FIG. 8 is a configuration diagram of the membrane separation device according to embodiment 2 of the present invention.

As shown in FIG. 8, the membrane separation device according to embodiment 2 of the present invention is configured by adding, to the target TMP increase speed setting means 13 of embodiment 1, database update means 40 for calculating a new target TMP increase speed with respect to the organic substance concentration measured by the organic substance concentration measurement means, and updating the relationship between the organic substance concentration in the treatment target water and the TMP increase speed, stored in the database 20.

The database update means 40 is connected to the membrane surface aeration flow amount control unit 16 via a signal line 71, and is connected to the database 20 via a signal line 72. The other configurations are the same as those in embodiment 1. Therefore, the same or corresponding parts are denoted by the same reference characters and the description thereof is omitted.

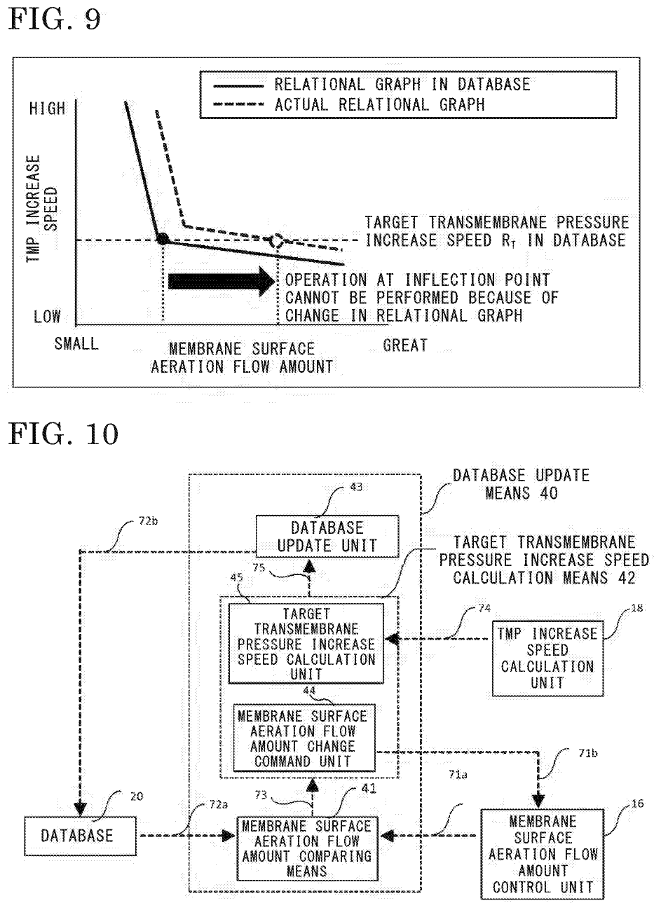

As filtration operation continues, variation in property of the filtration membrane, accumulation of inorganic substances, or the like can occur. These are factors that cause the TMP increase speed to change without depending on the organic substance concentration in the treatment target water 9. Therefore, as shown in FIG. 9, the relationship between the organic substance concentration in the treatment target water 9 and the TMP increase speed changes, and thus it might become difficult to set the membrane surface aeration flow amount at the inflection point.

Accordingly, it is necessary to update the database as appropriate by comparing the relationship between the organic substance concentration in the treatment target water 9 and the TMP increase speed stored in the database 20, and the relationship between the organic substance concentration in the treatment target water 9 and the TMP increase speed under actual operation.

As shown in FIG. 10, the database update means 40 includes: membrane surface aeration flow amount comparing means 41 which compares a membrane surface aeration flow amount Q_{M} when the TMP increase speed R_{T} selected on the basis of the value of the organic substance concentration measured by the organic substance concentration measurement means 19 and the TMP increase speed R_{M} calculated from the TMP measured by the pressure measurement unit have become equal to each other through control, with the membrane surface aeration flow amount Q_{T} corresponding to the target TMP increase speed R_{T}, stored in the database; target TMP increase speed calculation means 42 which, when the membrane surface aeration flow amount Q_{M} and the membrane surface aeration flow amount Q_{T} are different from each other in the membrane surface aeration flow amount comparing means 41, causes the membrane surface aeration flow amount control unit 16 to change the membrane surface aeration flow amount, and calculates a new target TMP increase speed R_{T}′; and a database update unit 43 which stores, in the database, the new target TMP increase speed R_{T}′ calculated by the target TMP increase speed calculation means 42, the membrane surface aeration flow amount Q_{T}′ corresponding thereto, and the value of the organic substance concentration measured by the organic substance concentration measurement means. Further, the target TMP increase speed calculation means 42 includes: a membrane surface aeration flow amount change command unit 44 which issues a command to the membrane surface aeration flow amount control unit 16 to change the membrane surface aeration flow amount; and a target TMP increase speed calculation unit 45 which calculates the target TMP increase speed R_{T}′ on the basis of the relationship between the membrane surface aeration flow amount when the membrane surface aeration flow amount has been changed by the command issued from the membrane surface aeration flow amount change command unit 44, and the TMP increase speed at that time.

The membrane surface aeration flow amount comparing means 41 is connected to the membrane surface aeration flow amount control unit 16 via a signal line 71a, connected to the database 20 via a signal line 72a, and connected to the target TMP increase speed calculation means 42 via a signal line 73. The membrane surface aeration flow amount change command unit 44 is connected to the membrane surface aeration flow amount control unit 16 via a signal line 71b. The target TMP increase speed calculation unit 45 is connected to the TMP increase speed calculation unit 18 via a signal line 74. The database update unit 43 is connected to the target TMP increase speed calculation means 42 via a signal line 75, and connected to the database 20 via a signal line 72b.

Next, a procedure for updating the database in embodiment 2 will be described. The membrane surface aeration flow amount control unit 16 performs control so that the TMP increase speed R_{T} selected on the basis of the value of the organic substance concentration measured by the organic substance concentration measurement means 19, and the TMP increase speed R_{M} calculated from the TMP measured by the pressure measurement unit 17, become equal to each other.

The value of the membrane surface aeration flow amount Q_{M} when the TMP increase speed R_{T} selected on the basis of the value of the organic substance concentration measured by the organic substance concentration measurement means 19 and the TMP increase speed R_{M} calculated from the TMP measured by the pressure measurement unit 17 have become equal to each other through control, is sent to the membrane surface aeration flow amount comparing means 41 via the signal line 71a. The value of the membrane surface aeration flow amount Q_{T} corresponding to the target TMP increase speed R_{T} stored in the database is sent to the membrane surface aeration flow amount comparing means 41 via the signal line 72a. The membrane surface aeration flow amount comparing means 41 compares the membrane surface aeration flow amount Q_{M} when the TMP increase speed R_{T} selected on the basis of the value of the organic substance concentration measured by the organic substance concentration measurement means 19 and the TMP increase speed R_{M} calculated from the TMP measured by the pressure measurement unit 17 have become equal to each other through control, with the membrane surface aeration flow amount Q_{T} corresponding to the target TMP increase speed R_{T} stored in the database, and sends the difference therebetween to the target TMP increase speed calculation means 42 via the signal line 43.

In the target TMP increase speed calculation means 42, if the membrane surface aeration flow amount Q_{H} when the TMP increase speed R_{T} selected on the basis of the value of the organic substance concentration measured by the organic substance concentration measurement means 19 and the TMP increase speed R_{M} calculated from the TMP measured by the pressure measurement unit 17 have become equal to each other through control, is equal to the membrane surface aeration flow amount Q_{T} corresponding to the target TMP increase speed R_{T} stored in the database, update for the database is not performed. On the other hand, if these values are different from each other, a new target TMP increase speed R_{T}′ and a membrane surface aeration flow amount Q=′ corresponding to the new target TMP increase speed R_{T}′ are calculated, and the calculated values are sent to the database update unit 43 via the signal line 75.

The target TMP increase speed calculation means 42 includes the membrane surface aeration flow amount change command unit 44 and the target TMP increase speed calculation unit 45. If the membrane surface aeration flow amount Q_{M} is smaller than the membrane surface aeration flow amount Q_{T}, the membrane surface aeration flow amount change command unit 44 issues a command to the membrane surface aeration flow amount control unit 16 via the signal line 71b to increase the membrane surface aeration flow amount. On the other hand, if the membrane surface aeration flow amount Q_{M} is greater than the membrane surface aeration flow amount Q_{T}, the membrane surface aeration flow amount change command unit 44 issues a command to the membrane surface aeration flow amount control unit 16 via the signal line 71b to decrease the membrane surface aeration flow amount. After the membrane surface aeration flow amount is changed by the membrane surface aeration flow amount control unit 16, the TMP increase speed calculation unit 18 calculates the TMP increase speed R_{M}, and sends the calculated value to the target TMP increase speed calculation unit 45 via the signal line 74. Increase/decrease of the membrane surface aeration flow amount and calculation of the TMP increase speed R_{M} are repeatedly performed until the membrane surface aeration flow amount reaches the membrane surface aeration flow amount Q_{T}.

The target TMP increase speed calculation unit 45 calculates an inflection point from the relationship between the TMP increase speed and the membrane surface aeration flow amount obtained through the above operation, and as described above, calculates the TMP increase speed at the inflection point as a new target TMP increase speed R_{T}′, and calculates the membrane surface aeration flow amount at the inflection point as a membrane surface aeration flow amount Q_{T}′ corresponding to the new target TMP increase speed R_{T}′. Regarding a calculation method for the inflection point, the inflection point may be calculated on the basis of a value obtained by dividing the amount of change in the TMP increase speed by the amount of change in the membrane surface aeration flow amount, i.e., the calculated value of the change rate of the TMP increase speed with respect to the amount of change in the membrane surface aeration flow amount. Alternatively, the inflection point may be calculated by using an expression for calculating operation cost using the membrane surface aeration flow amount and the TMP increase speed as parameters. For example, the following expression can be used. The TMP increase speed and the membrane surface aeration flow amount which are calculated by using the following expression and which minimize the operation cost, may be used as an inflection point.

[Operation cost]=f(TMP increase speed, membrane surface aeration flow amount)

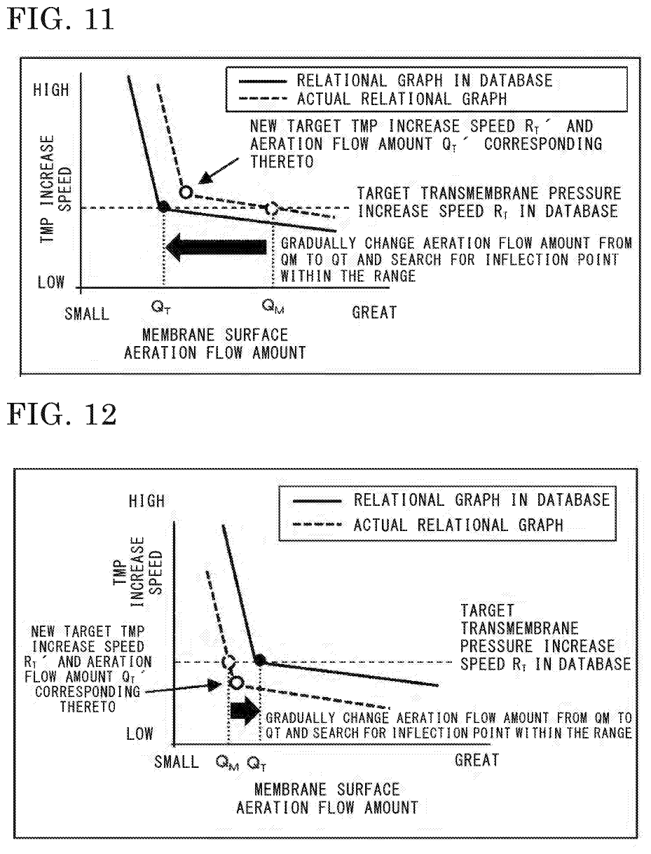

Here, with reference to FIG. 11 and FIG. 12, the database update means will be described. The organic substance concentration in the treatment target water 9 is measured, and on the basis of the measured value, a target TMP increase speed R_{T} is selected from the database. Further, the membrane surface aeration flow amount is controlled so that the TMP increase speed R_{M} becomes the target TMP increase speed R_{T}. The membrane surface aeration flow amount at that time should correspond to the membrane surface aeration flow amount Q_{T} in the data in the database, but if the actual membrane surface aeration flow amount is the membrane surface aeration flow amount Q_{M}, it is necessary to update the relational graph between the membrane surface aeration flow amount and the TMP increase speed for the organic substance concentration. As shown in FIG. 11, in the case where the membrane surface aeration flow amount Q_{M} is smaller than the membrane aeration flow amount Q_{T}, the membrane surface aeration flow amount is gradually increased from Q_{Q} to Q_{T}, and as shown in FIG. 12, in the case where the membrane surface aeration flow amount Q_{M} is greater than the membrane aeration flow amount Q_{T}, the membrane surface aeration flow amount is gradually decreased from Q_{M} to Q_{T}, while the TMP increase speed is calculated each time. Further, from the newly calculated relational graph between the membrane surface aeration flow amount and the TMP increase speed, the inflection point is calculated by using the calculation method for an inflection point as described above, and the TMP increase speed and the membrane surface aeration flow amount at the calculated inflection point are calculated as a new target TMP increase speed R_{T}′ and a membrane surface aeration flow amount Q_{T}′ corresponding thereto.

The database update unit 43 sends the new target TMP increase speed R_{T}′ and the membrane surface aeration flow amount Q_{T}′ corresponding to the new target TMP increase speed R_{T}′ which are calculated by the target TMP increase speed calculation means 42, to the database 20 via the signal line 72b, thereby updating the database. Further, the membrane surface aeration flow amount change command unit 44 issues a command to the membrane surface aeration flow amount control unit 16 via the signal line 71b so as to cause the membrane surface aeration flow amount to be the membrane surface aeration flow amount Q_{T}′. After the membrane surface aeration flow amount control unit 16 performs control so that the membrane surface aeration flow amount becomes the membrane surface aeration flow amount Q_{T}′, the update procedure for the database is finished.

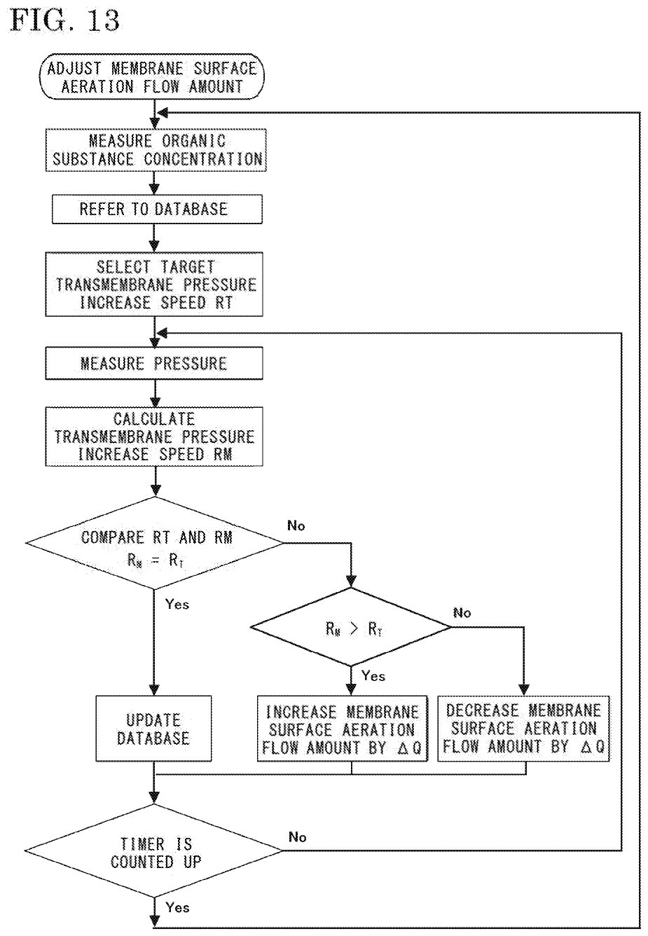

FIG. 13 shows a flowchart of an adjustment procedure for the membrane surface aeration flow amount in embodiment 2.

As shown in FIG. 13, the flowchart of the adjustment procedure for the membrane surface aeration flow amount in embodiment 2 of the present invention is obtained by adding the database update procedure to the flowchart in embodiment 1. The other procedure steps are the same as those in embodiment 1, and therefore the description thereof is omitted. That is, in the adjustment procedure for the membrane surface aeration flow amount in embodiment 2 of the present invention, the membrane surface aeration flow amount is controlled so that the TMP increase speed R_{T} selected on the basis of the value of the organic substance concentration measured by the organic substance concentration measurement means 19 and the TMP increase speed R_{M} calculated from the TMP measured by the pressure measurement unit 17 become equal to each other, and further, when these values have become equal to each other through the control, the database is updated.

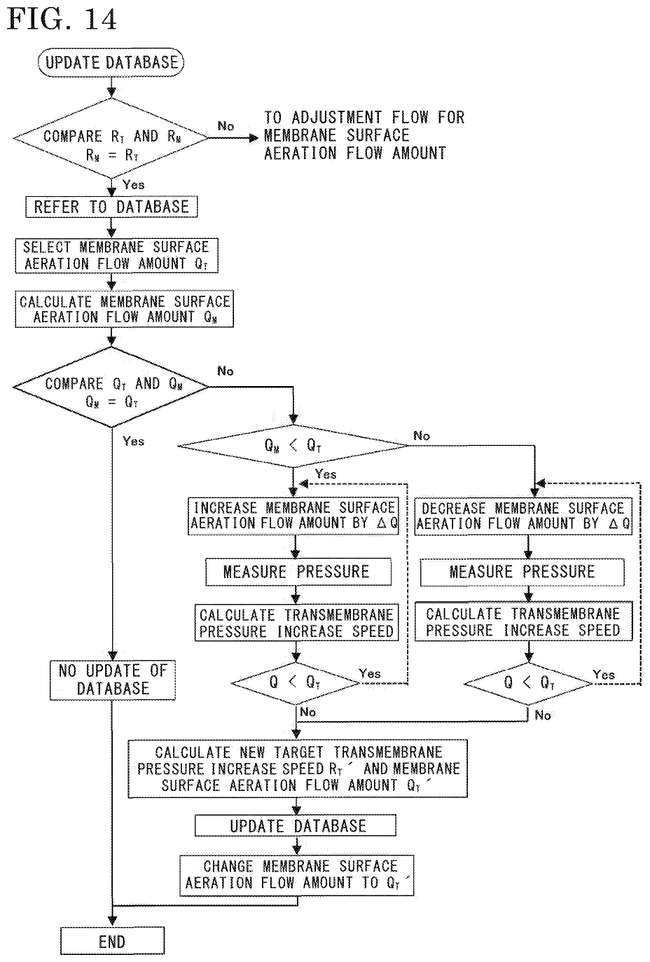

FIG. 14 shows a flowchart of the database update procedure in embodiment 2. The membrane surface aeration flow amount control unit 16 performs control so that the TMP increase speed R_{T} selected on the basis of the value of the organic substance concentration measured by the organic substance concentration measurement means 19 and the TMP increase speed R_{M} calculated from the TMP measured by the pressure measurement unit 17 become equal to each other. The value of the membrane surface aeration flow amount Q_{T} corresponding to the target TMP increase speed R_{T} is selected from the data in the database 20. In addition, the TMP increase speed calculation unit 18 calculates the value of the membrane surface aeration flow amount Q_{Q} at the time when the TMP increase speed R_{T} selected on the basis of the value of the organic substance concentration measured by the organic substance concentration measurement means 19 and the TMP increase speed R_{M} calculated from the TMP measured by the pressure measurement unit 17 have become equal to each other through control.

Next, the membrane surface aeration flow amount Q_{M} and the membrane surface aeration flow amount Q_{T} are compared with each other. If the membrane surface aeration flow amount Q_{M} and the membrane surface aeration flow amount Q_{T} are equal to each other or the absolute value of a difference between the membrane surface aeration flow amount Q_{T} and the membrane surface aeration flow amount Q_{T} is smaller than an optionally set value b, update of the database is not performed. If the membrane surface aeration flow amount Q_{M} is smaller than the membrane surface aeration flow amount Q_{T} or the membrane surface aeration flow amount Q_{M} is greater than the membrane surface aeration flow amount Q_{T} by the optionally set value b or greater, the membrane surface aeration flow amount is increased by ΔQ. If the membrane surface aeration flow amount Q_{M} is greater than the membrane surface aeration flow amount Q_{T} or the membrane surface aeration flow amount Q_{M} is greater than the membrane surface aeration flow amount Q_{T} by the optionally set value b or greater, the membrane surface aeration flow amount is decreased by ΔQ. The optionally set value b can be optionally set in consideration of control error of the membrane surface aeration flow amount and convenience for operation in flow amount control. The change amount ΔQ for the membrane surface aeration flow amount can be optionally set, and may be set on the basis of a difference between the membrane surface aeration flow amount Q_{M} and the membrane surface aeration flow amount Q, or may be set on the basis of the change rate of the TMP increase speed. After the membrane surface aeration flow amount is increased/decreased, the TMP increase speed is calculated. The changing of the membrane surface aeration flow amount and the calculation for the TMP increase speed R_{M} are repeatedly performed until the membrane surface aeration flow amount reaches the membrane surface aeration flow amount Q_{T}. In other words, while the membrane surface aeration flow amount is changed from the membrane surface aeration flow amount Q_{M} to the membrane surface aeration flow amount Q_{T}, the TMP increase speed is measured each time.

The target TMP increase speed calculation unit 45 calculates an inflection point from the relationship between the TMP increase speed R_{M} and the membrane surface aeration flow amount Q_{M} obtained through the above operation, and as described above, calculates the TMP increase speed at the inflection point as a new target TMP increase speed R_{T}′, and calculates the membrane surface aeration flow amount at the inflection point as a membrane surface aeration flow amount Q_{T}′ corresponding to the new target TMP increase speed R_{T}′. The calculated new target TMP increase speed R_{T}′ and the calculated membrane surface aeration flow amount Q_{T}′ corresponding to the new target TMP increase speed R_{T}′ are sent to the database 20, whereby the database is updated. Finally, the membrane surface aeration flow amount is controlled so that the membrane surface aeration flow amount becomes the membrane surface aeration flow amount Q_{T}′, and thus the database update procedure is finished.

As described above, in the invention according to embodiment 2, the relationship between the organic substance concentration in the treatment target water and the TMP increase speed, stored in the database, is updated, so that the target TMP increase speed can be set accurately. Therefore, it is possible to reduce the membrane surface aeration flow amount and reduce the operation cost for the entire device.

### Embodiment 3

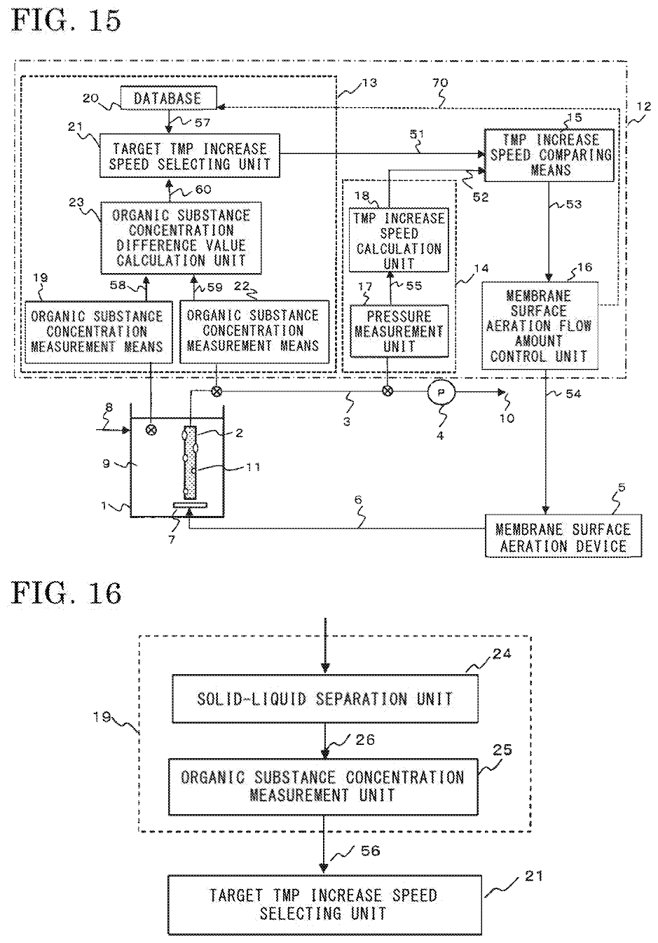

Next, a membrane separation device according to embodiment 3 of the present invention will be described with reference to FIG. 15. FIG. 15 is a configuration diagram of the membrane separation device according to embodiment 3 of the present invention.

As shown in FIG. 15, the membrane separation device according to embodiment 3 of the present invention is obtained by adding, to the target TMP increase speed setting means 13 of embodiment 1, organic substance concentration measurement means 22 for measuring the organic substance concentration in filtered water in the filtered water pipe 3, and an organic substance concentration difference value calculation unit 23. It is noted that the organic substance concentration measurement means 22 may have completely the same configuration as the organic substance concentration measurement means for measuring the organic substance concentration in the treatment target water 9 as shown in FIG. 2.

The organic substance concentration measurement means 19 for measuring the organic substance concentration in the treatment target water 9 in the membrane separation tank 1 is connected to the organic substance concentration difference value calculation unit 23 via a signal line 58, and the organic substance concentration measurement means 22 for measuring the organic substance concentration in the filtered water in the filtered water pipe 3 is connected to the organic substance concentration difference value calculation unit 23 via a signal line 59. The organic substance concentration difference value calculation unit 23 is connected to the target TMP increase speed selecting unit 21 via a signal line 60. The other configurations are the same as those in embodiment 1. Therefore, the same or corresponding parts are denoted by the same reference characters and the description thereof is omitted.

Next, operation of the membrane separation device in embodiment 3 will be described. The organic substance concentration measurement means 22 measures the organic substance concentration in the filtered water that is passing through the filtered water pipe 3 after the treated water is filtered by the separation membrane 2. The value of the organic substance concentration measured by the organic substance concentration measurement means 22 is sent to the organic substance concentration difference value calculation unit 23 via the signal line 59. The organic substance concentration difference value calculation unit 23 calculates a difference between the respective organic substance concentrations measured by the organic substance concentration measurement means 19 and the organic substance concentration measurement means 22, specifically, a value obtained by subtracting the organic substance concentration measured by the organic substance concentration measurement means 22 from the organic substance concentration measured by the organic substance concentration measurement means 19, and the organic substance concentration difference value calculation unit 23 sends the calculated value to the target TMP increase speed selecting unit 21 via the signal line 60.

The organic substance concentration measurement means 22 is means for measuring the concentration of organic substances contained in the filtered water, and may perform the measurement by an organic substance concentration sensor provided to the filtered water pipe 3, or may perform the measurement by the filtered water being supplied to the organic substance concentration sensor. Alternatively, the filtered water discharged from the filtration pump 4 may be sampled and the organic substance concentration thereof may be measured. The database 20 is connected to the target TMP increase speed selecting unit 21 via the signal line 57. In the database 20, water quality acquired by the past water treatments, e.g., the value obtained by subtracting the organic substance concentration measured by the organic substance concentration measurement means 22 from the organic substance concentration measured by the organic substance concentration measurement means 19, temporal change in TMP, and the like, are recorded and stored as a database.

The target TMP increase speed selecting unit 21 selects a target TMP increase speed R_{T} on the basis of the data stored in the database 20 and the concentration difference calculated by the organic substance concentration difference value calculation unit 23 (the value obtained by subtracting the organic substance concentration measured by the organic substance concentration measurement means 22 from the organic substance concentration measured by the organic substance concentration measurement means 19). Preferably, the target TMP increase speed R_{T} is 0.01 to 40 kPa/h. The other operations are the same as those in embodiment 1.

Here, not all the organic substances contained in the treatment target water 9 in the membrane separation tank 1 are necessarily cause of clogging of the separation membrane 2, and some of the organic substances pass through the separation membrane 2, to be contained in the filtered treated water 10. Therefore, by detecting a difference in the organic substance concentration between before and after passing through the separation membrane 2, i.e., by calculating the difference value between the concentration of organic substances contained in the treatment target water 9 in the membrane separation tank 1 and the concentration of organic substances contained in the filtered treated water 10, it is possible to grasp the amount of organic substances captured by the separation membrane 2, together with the amount of filtered water. That is, it is possible to indirectly calculate the amount of organic substances that can cause clogging of the separation membrane 2, and in particular, in the case of using an ultraviolet absorbance as the organic substance concentration, the amount of organic substances captured by the separation membrane 2 can be calculated accurately, and immediately because absorbance measurement can be instantly performed.

As described above, in the invention according to embodiment 3, it is possible to accurately calculate the concentration of organic substances that can cause clogging of the membrane, by calculating the difference value between the concentration of organic substances contained in the treatment target water 9 in the membrane separation tank 1 and the concentration of organic substances contained in the filtered water. Then, the target TMP increase speed R_{T} is set in accordance with the difference value, and the membrane surface aeration flow amount is controlled so that the TMP increase speed is maintained at the target TMP increase speed R_{T}. Therefore, it is possible to reduce the membrane surface aeration flow amount and reduce the operation cost for the entire device.

### Embodiment 4

Next, a membrane separation device according to embodiment 4 of the present invention will be described with reference to FIG. 16. FIG. 16 illustrates organic substance concentration measurement means used in the membrane separation device according to embodiment 4 of the present invention.

The organic substance concentration measurement means 19 in embodiment 4 of the present invention includes: a solid-liquid separation unit 24 which performs solid-liquid separation for suspended solids in the treatment target water 9 in the membrane separation tank 1, by any of filtration separation, centrifugal separation, and precipitation separation; and an organic substance concentration measurement unit 25 which measures the organic substance concentration in the liquid obtained through solid-liquid separation by the solid-liquid separation unit 24.

The treatment target water 9 in the membrane separation tank 1 is supplied to the solid-liquid separation unit 24, and is subjected to solid-liquid separation by any of filtration separation, centrifugal separation, and precipitation separation, whereby solid-liquid separated liquid 26 is obtained. The solid-liquid separated liquid 26 obtained by the solid-liquid separation unit 24 is supplied to the organic substance concentration measurement unit 25, and the organic substance concentration in the solid-liquid separated liquid 26 is measured.

In the case of performing filtration separation in the solid-liquid separation unit 24, preferably, the pore diameter of filter paper or a filtration membrane used for the filtration separation is 0.2 to 10 μm. However, this pore diameter is required to be greater than that of the separation membrane 2. If the pore diameter for the filtration separation is smaller than that of the separation membrane 2, the filter paper used for the filtration separation is to capture more organic substances than the separation membrane 2, in filtration separation. Therefore, it is impossible to accurately grasp the amount of organic substances that are captured by the separation membrane 2. The same applies for the case where the pore diameter of the filtration membrane is smaller than 0.2 μm. On the other hand, in the case where the pore diameter of the filtration membrane is greater than 10 μm, a solid material and a turbid component pass through the filter paper or the filtration membrane used for the filtration separation, so that the organic substance concentration cannot be measured accurately.

In the case of performing centrifugal separation in the solid-liquid separation unit 24, preferably, the centrifugal separation is performed with a gravitational acceleration of 1000 to 10000 G. If the gravitational acceleration is smaller than 1000 G, the solid-liquid separation is not sufficiently performed and a solid material and a turbid component pass through the filter paper or the filtration membrane used for the filtration separation. Therefore, the organic substance concentration cannot be measured accurately. If the gravitational acceleration is greater than 10000 G, the scale of the device is great and therefore the device cannot be installed on a side of the membrane separation device.

In the case of performing precipitation separation in the solid-liquid separation unit 24, the precipitation period is desired to be 15 minutes to 2 hours. If the precipitation period is shorter than 15 minutes, solid-liquid separation is not sufficiently performed and a solid material and a turbid component pass through the filter paper or the filtration membrane used for the filtration separation. Therefore, the organic substance concentration cannot be measured accurately. If the precipitation period is longer than 2 hours, the property of the treatment target water 9 changes, and therefore the organic substance concentration cannot be measured accurately.

Solid materials existing in the treatment target water 9, such as activated sludge, are deposited on the membrane surface, whereby clogging of the membrane occurs. However, this is suppressed by execution of membrane surface aeration. Some of organic substances in the treatment target water 9 stay at the surface of the separation membrane 2 and cannot reach the inside of the separation membrane 2 because the sizes thereof are large. Such organic substances can be removed by membrane surface aeration. The organic substances having smaller sizes penetrate into the separation membrane 2, so that some of them are captured by the separation membrane 2 and others pass through the separation membrane 2 to be discharged through the filtration pump 4 together with the filtered treated water 10. Such organic substances captured by the separation membrane 2 are clogging materials, which can cause increase in the TMP. The organic substances captured by the separation membrane 2 can be measured by the above-described method. That is, the organic substances in the treatment target water 9 that stay at the membrane surface and cannot reach the inside of the separation membrane 2, are removed in advance by filtration separation, centrifugal separation, precipitation separation, or the like, and the organic substance concentration of the treatment target water 9 from which such organic substances have been removed is measured, whereby the TMP increase speed can be accurately determined.

As described above, in the invention according to embodiment 4, the treatment target water in the membrane separation tank is subjected to solid-liquid separation by any of filtration separation, centrifugal separation, and precipitation separation, and the organic substance concentration in the liquid obtained by solid-liquid separation is measured, whereby the organic substances that can cause clogging of the membrane can be measured more accurately.

It is noted that the solid-liquid separated liquid 26 obtained by the solid-liquid separation unit 24 performing solid-liquid separation of the treatment target water 9 in the membrane separation tank 1, may be supplied to the organic substance index measurement means 27 of the organic substance concentration measurement means 19 described in embodiment 1. Thus, it is possible to measure the organic substance index of at least one of UV, TOC, COD, BOD, humic acid concentration, sugar concentration, and protein concentration. It has been confirmed that the substances corresponding to these indexes are readily captured by the separation membrane and can be used as indexes for clogging.

In FIG. 16, the organic substance concentration measured by the organic substance concentration measurement unit 25 is outputted to the target TMP increase speed selecting unit 21. However, the organic substance concentration may be outputted to the organic substance concentration difference value calculation unit 23 described in FIG. 15 in embodiment 3.

### Embodiment 5

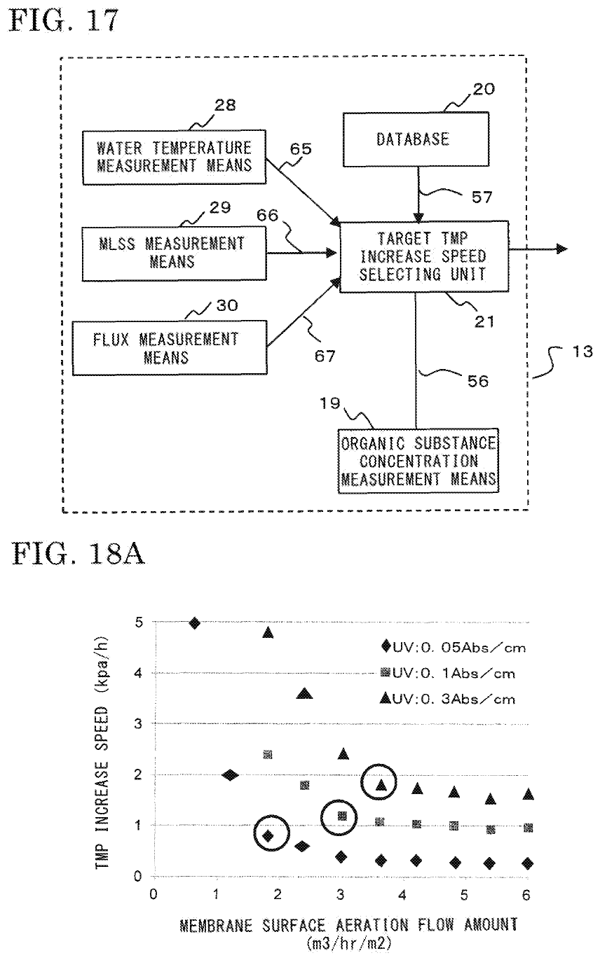

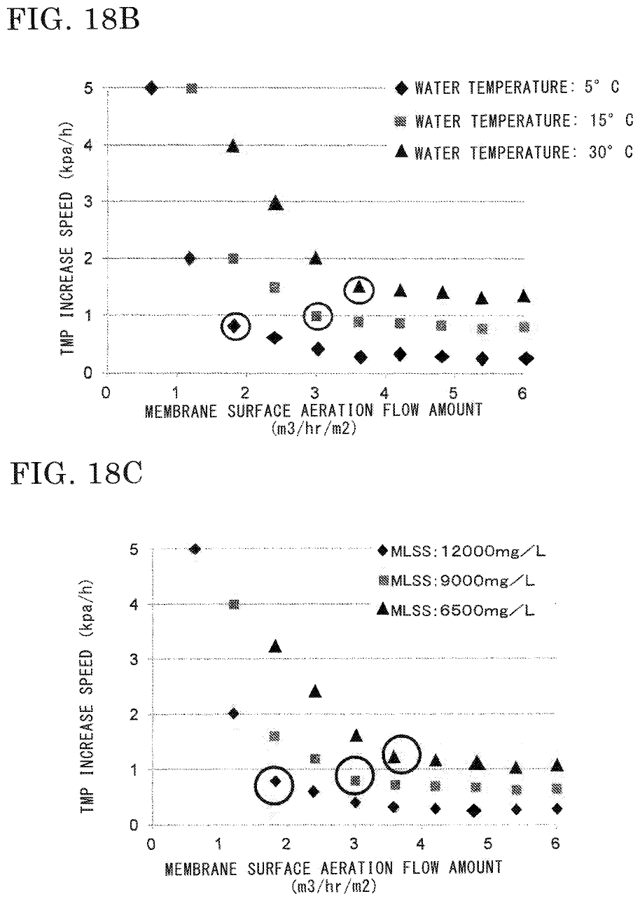

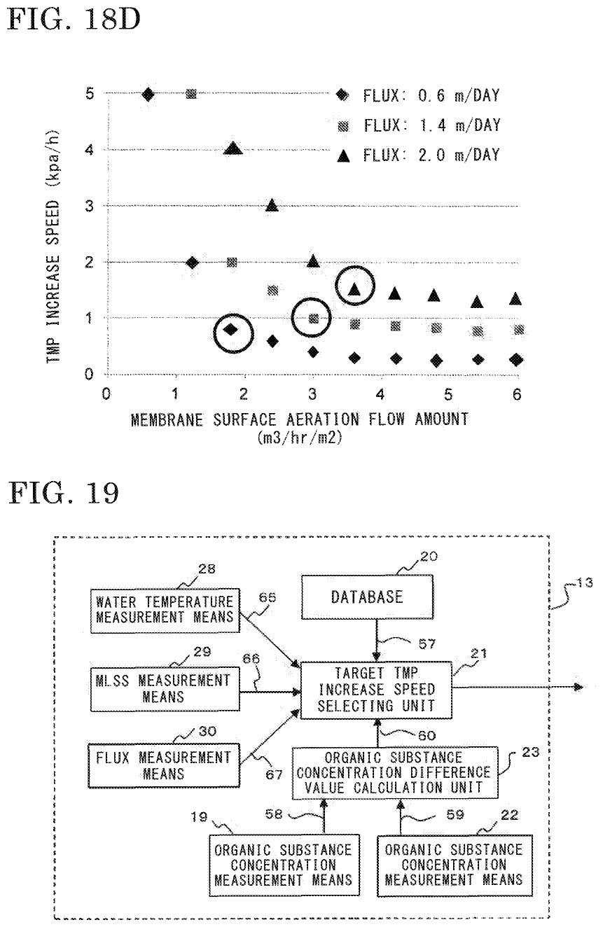

Next, a membrane separation device according to embodiment 5 of the present invention will be described with reference to FIG. 17 and FIG. 18. FIG. 17 is a configuration diagram of target TMP increase speed setting means 13 used in the membrane separation device according to embodiment 5.

The target TMP increase speed setting means 13 in embodiment 5 of the present invention includes the database 20, the organic substance concentration measurement means 19, and the target TMP increase speed selecting unit 21, and in addition, includes at least one of: water temperature measurement means 28 for measuring the water temperature of the treatment target water in the membrane separation tank 1; MLSS measurement means 29 for measuring a mixed liquor suspended solid (MLSS, suspended solid in mixed liquor in aeration tank) concentration; and flux measurement means 30 for measuring the filtration flux of the separation membrane 2.

The water temperature measurement means 28 is connected via a signal line 65, the MLSS measurement means is connected via a signal line 66, and the flux measurement means is connected via a signal line 67, to the target TMP increase speed selecting unit 21. The other configurations are the same as those in embodiments 1 to 4, and therefore the description thereof is omitted.

Next, operation of the membrane separation device according to embodiment 5 will be described.

The water temperature measurement means 28 is means for measuring the water temperature of the treatment target water 9, and may perform the measurement by a water temperature sensor provided to the membrane separation tank 1, or may perform the measurement by the treatment target water 9 being supplied to the water temperature sensor. The MLSS measurement means 29 is means for measuring the MLSS concentration, the turbidity, the suspended solid (SS) concentration, or the like of the treatment target water 9, and may perform the measurement by an MLSS concentration sensor, a turbidity meter, or the like provided to the membrane separation tank 1, or may perform the measurement by the treatment target water being supplied to the MLSS concentration sensor, the turbidity meter, or the like. Alternatively, the treatment target water 9 may be sampled and the MLSS concentration, the SS concentration, the turbidity, or the like may be measured by manual analysis.

The flux measurement means 30 is means for measuring the filtration flux of the separation membrane 2, and performs the measurement by a flow rate sensor provided to the filtered water pipe 3, or calculates the flow rate by measuring the amount of water filtered per certain period. Further, the flow rate value is divided by the membrane area of the separation membrane 2, whereby the filtration flux can be measured. The values obtained by the water temperature measurement means 28, the MLSS measurement means 29, and the flux measurement means 30 are sent to the target TMP increase speed selecting unit 21 via the signal lines 65, 66, and 67, respectively.

The target TMP increase speed selecting unit 21 selects the membrane surface aeration flow amount appropriate for the water quality of the treatment target water 9 in the membrane separation device at present, on the basis of the past data of the TMP increase speed, the membrane surface aeration flow amount, the organic substance concentration, and the like sent from the database 20, the past operation data about the water temperature measurement means 28, the MLSS measurement means 29, and the flux measurement means 30, data about such matters obtained through experiments or the like in the past, and the like. In operation of the membrane separation device, preferably, the water temperature is 1 to 50° C. At a water temperature of 1° C. or lower or a water temperature of 50° C. or higher, the durability of the separation membrane 2 reduces, and thus it is difficult to perform stable operation of the membrane separation device. Preferably, the MLSS concentration and the SS concentration are 1 to 30000 mg/L.

Preferably, the turbidity of the treatment target water 9 is 0.1 to 10000 degrees. In the case where the MLSS concentration or the SS concentration is smaller than 1 mg/L or the turbidity is smaller than 0.1, filtration is not needed. In the case where the MLSS concentration or the SS concentration is 30000 mg/or higher, or the turbidity is 10000 degrees or higher, the separation membrane 2 is clogged in a short time, and therefore the treatment target water 9 having such water quality is not suitable to filtration. Preferably, the filtration flux of the separation membrane 2 is 0.01 to 10 m/day. If the filtration flux is smaller than 0.01 m/day, an enormous amount of separation membrane 2 is needed and this is not feasible in water treatment. If the filtration flux is 10 m/day or greater, the separation membrane 2 is clogged in a short time, and even if the separation membrane 2 is washed, the TMP is not restored. Therefore, filtration cannot be carried out.

Hereinafter, a specific control method for the membrane surface aeration flow amount will be described. As the water temperature decreases, the viscosity of the water increases, and thus the TMP increase speed increases. In addition, if the MLSS concentration, the SS concentration, the turbidity, or the like increases, the separation membrane 2 is more readily clogged, and thus the TMP increase speed increases. In addition, as the filtration flux increases, the rate at which the water passes through the separation membrane 2 increases, so that clogging is promoted and the TMP increase speed increases. Therefore, measuring such water quality items is important for operating the membrane separation device stably while keeping the TMP increase speed at an appropriate value, i.e., operating the membrane separation device while controlling the TMP increase speed.

Therefore, as the water temperature decreases, as the MLSS concentration, the SS concentration, or the turbidity increases, or as the filtration flux increases, the TMP increase speed increases. It is noted that one, some, or all of the water temperature measurement means 28, the MLSS measurement means 29, and the flux measurement means 30 may be used in combination.

As a database, the ones shown in FIGS. 18A to 18D are used. That is, FIG. 18A shows a database indicating the relationship among the membrane surface aeration flow amount, the TMP increase speed, and the ultraviolet absorbance. FIG. 18B shows a database indicating the relationship among the membrane surface aeration flow amount, the TMP increase speed, and the water temperature. FIG. 18C shows a database indicating the relationship among the membrane surface aeration flow amount, the TMP increase speed, and suspended solids in mixed liquor in the aeration tank. FIG. 18D shows a database indicating the relationship among the membrane surface aeration flow amount, the TMP increase speed, and the filtration flux. In these graphs, circles indicate inflection points.

As shown in FIGS. 18A to 18D, in combination of organic substance concentrations (ultraviolet absorbance (UV) for wavelength of 254 nm), water temperatures, MLSS concentrations (which may be replaced with SS concentration or turbidities), and filtration fluxes, the relationships of the membrane surface aeration flow amount and the TMP increase speed are stored in the database 20 on the basis of operation data or experiment data in the past.

In this case, even if not all of such data are prepared, it is possible to use them as a database by interpolating data thereamong. For example, in the case where data for water temperature of 15° C. and water temperature of 30° C. exist in the database, when operation is performed at a water temperature of 25° C., the average values of the membrane surface aeration flow amounts and the TMP increase speeds for both water temperatures may be used as a database. In this way, a new database may be formed by interpolation based on the existing database, or a relationship in which data are interpolated on the basis of the existing database may be prepared in advance to form a new database.

That is, a formula for calculating the TMP increase speed may be prepared using the membrane surface aeration flow amount, the organic substance concentration, the water temperature, the MLSS concentration, and the filtration flux as parameters. For example, the following formula can be used.

It is noted that, instead of using the sum of all the parameters, a formula including multiplication, division, exponentiation, and logarithm in a mixed manner may be prepared, and it is important to prepare a formula that can reproduce the past operation data.

[TMP increase speed]=α[membrane surface aeration flow amount]+β[organic substance concentration]+γ[water temperature]+δ[MLSS concentration]+ε[filtration flux](α, β, γ, δ, and εare constants) (1)

As described above, in the invention according to embodiment 5, it is possible to set the target TMP increase speed more accurately even if at least one of the organic substance concentration, the water temperature, and the MLSS concentration of the treatment target water 9 in the membrane separation tank 1 and the filtration flux of the separation membrane 2 has changed.

### Embodiment 6

Next, a membrane separation device according to embodiment 6 of the present invention will be described with reference to FIG. 19. FIG. 19 illustrates the target TMP increase speed setting means 13 used in the membrane separation device according to embodiment 6 of the present invention.

In FIG. 19, the configuration is the same as in embodiment 5 except that the organic substance concentration measurement means 22 is connected to the organic substance concentration difference value calculation unit 23 via the signal line 59.

As described above, not all the organic substances contained in the treatment target water 9 in the membrane separation tank 1 are necessarily cause of clogging of the separation membrane 2, and some of the organic substances pass through the separation membrane 2, to be contained in the filtered treated water 10. Therefore, by detecting a difference in the organic substance concentration between before and after passing through the separation membrane 2, i.e., by calculating the difference value between the concentration of organic substances contained in the treatment target water 9 in the membrane separation tank 1 and the concentration of organic substances contained in the filtered treated water 10, it is possible to grasp the amount of organic substances captured by the separation membrane 2, together with the amount of filtered water. Thus, it is possible to directly confirm the amount of organic substances captured by the separation membrane 2, and therefore, when the organic substance concentration in the treatment target water 9 varies, the degree of clogging of the separation membrane 2 can be easily grasped and it becomes easy to take measures for reducing the organic substance concentration in the treatment target water 9 by decreasing the water treatment load, increasing the SRT, or increasing the dissolved oxygen concentration, for example.

### EXAMPLES

Hereinafter, the present invention will be described in detail with reference to examples. However, the present invention is not limited to the following examples.

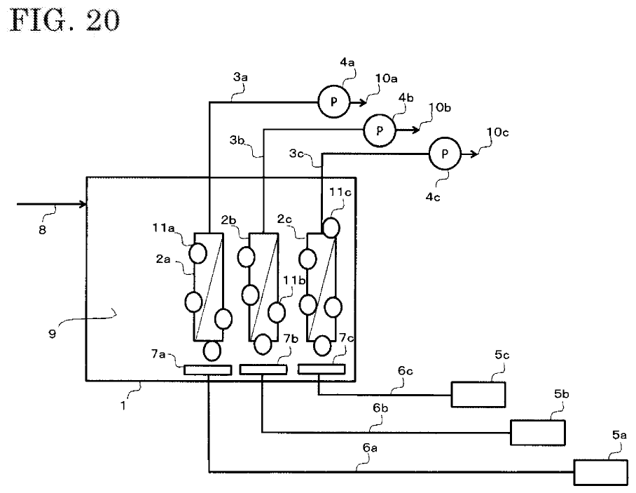

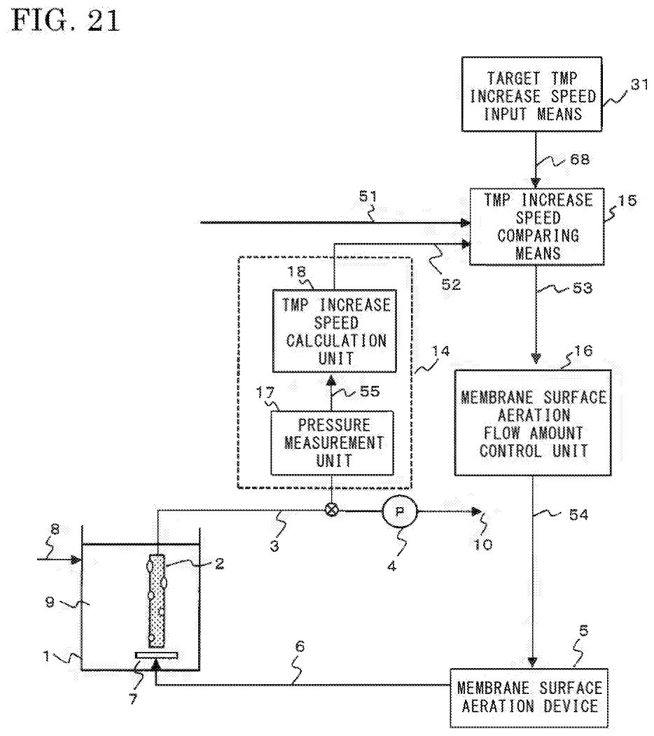

In a membrane separation device shown in FIG. 20, three separation membranes 2a to 2c (characters a, b, c are attached for discrimination, the same applies hereafter) were immersed at the same time, and diffuser pipes 7a to 7c were provided below the respective separation membranes 2, whereby membrane filtration was performed. At that time, the TMP increase speed changing means 12 shown in FIG. 1 was applied to one separation membrane 2a, the TMP increase speed changing means 12 shown in FIG. 15 was applied to another separation membrane 2b, and membrane surface aeration flow amount control shown in FIG. 21 was applied to the last one separation membrane 2c. It is noted that the water temperature of the treatment target water was 30° C. and the MLSS concentration was 9000 mg/L.

### Example 1

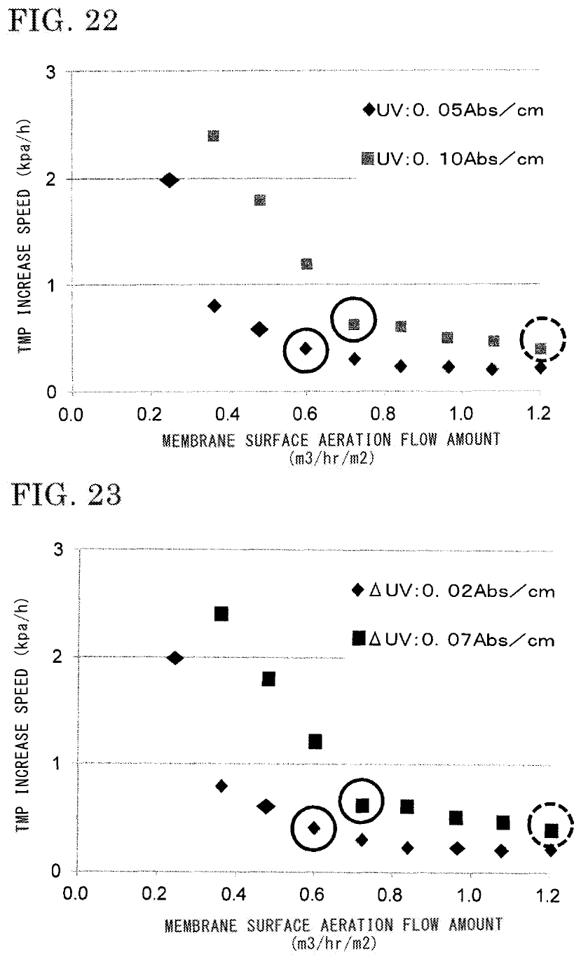

In Example 1, using the separation membrane 2 having a membrane area of 1 m², the treatment target water 9 in the membrane separation tank 1 was filtered at a filtration flux of 2.0 m/day. In order to measure the organic substance concentration in the treatment target water, the treatment target water 9 was filtered by a filter having a pore diameter of 1 μm, and the absorbance (UV254) of the filtered liquid for a wavelength of 254 nm was measured. Further, on the basis of the measured value of the UV254, a target TMP increase speed was selected with reference to the relationship between the membrane surface aeration flow amount and the TMP increase speed shown in FIG. 22, obtained from the database 20, and the membrane surface aeration flow amount of the membrane surface aeration device was controlled so that the measurement value of the TMP increase speed was maintained at the target TMP increase speed R_{T}.

One hour later from the start of the filtration, the value of the UV254 was 0.05 Abs/cm and the TMP increase speed at the inflection point was 0.4 kPa/h. Then, the membrane surface aeration flow amount of the membrane surface aeration device was controlled at 0.60 m³/hr/m² so that the TMP increase speed measurement value was maintained at the target TMP increase speed R_{T}. One more hour later from the start of the filtration, the water quality of the inflow water changed, so that the water quality of the treatment target water 9 in the membrane separation tank 1 also changed and the UV254 increased to 0.10 Abs/cm. The target TMP increase speed R_{T} at that time was 0.7 kPa/h as shown in the database in FIG. 22, and the membrane surface aeration flow amount per membrane area was 0.72 m³/hr/m².

### Example 2

In Example 2, the inflow water 8 was supplied to the membrane separation tank 1, and using the separation membrane 2 having a membrane area of 1 m², the treatment target water 9 in the membrane separation tank 1 was filtered at a filtration flux of 2.0 m/day. In order to measure the organic substance concentration in the treatment target water, the treatment target water 9 was filtered by a filter having a pore diameter of 1 μm, and the UV254 of the filtered liquid was measured. Further, in order to measure the concentration of organic substances contained in the filtered treated water 10, the UV254 of the filtered water was measured. The UV254 of the filtered liquid of the treatment target water 9 and the UV254 of the filtered water were outputted to the organic substance concentration difference value calculation unit 23. Then, on the basis of the organic substance concentration difference value, a target TMP increase speed was selected with reference to the relationship between the membrane surface aeration flow amount and the TMP increase speed shown in FIG. 23 in the database 20, and the membrane surface aeration flow amount of the membrane surface aeration device was controlled so that the TMP increase speed measurement value was maintained at the target TMP increase speed.

One hour later from the start of the filtration, a difference ΔUV254 between the UV254 of the treatment target water 9 and the UV254 of the filtered treated water 10 was 0.02 Abs/cm, and the TMP increase speed at the inflection point was 0.4 kPa/h. Accordingly, the membrane surface aeration flow amount of the membrane surface aeration device was controlled at 0.6 m³/hr/m² so that the TMP increase speed measurement value was maintained at the target TMP increase speed R_{T}. However, one more hour later from the start of the filtration, the water quality of the inflow water changed, so that the water quality of the treatment target water 9 in the membrane separation tank 1 also changed and a difference between the UV254 of the treatment target water 9 and the UV254 of membrane filtered water 3 increased to 0.07 Abs/cm. At that time, the target TMP increase speed R_{T} was 0.7 kPa/h as shown in the database in FIG. 23, and the membrane surface aeration flow amount per membrane area was 0.72 m³/hr/m².

### Comparative Example

In the comparative example, the same filtration operation as in Example 1 was performed except that the target TMP increase speed R_{T} was set to a fixed value in advance without measuring the organic substance concentration in the treatment target water 9. Target TMP increase speed input means 31 fixed the target TMP increase speed R₇ at 0.4 kPa/h and outputs this target TMP increase speed to the TMP increase speed comparing means 15. Further, the membrane surface aeration flow amount per membrane area, of the membrane surface aeration device, was controlled at 0.6 m³/h/m² so that the TMP increase speed measurement value was maintained at the target TMP increase speed R_{T}. However, one more hour later from the start of the filtration, the water quality of the inflow water changed, so that the water quality of the treatment target water 9 in the membrane separation tank 1 also changed. Accordingly, in order to maintain the TMP increase speed at the target TMP increase speed 0.4 kPa/h, the membrane surface aeration flow amount was set at 1.2 m³/h/m² as shown by broken-line circles in FIG. 22 and FIG. 23. This value was significantly greater than the membrane surface aeration flow amount 0.72 m³/hr/m² in Example 1 and Example 2.

In Example 1 and Example 2, as compared to the comparative example, the target TMP increase speed could be changed in accordance with the organic substance concentration in the treatment target water or a difference value between the organic substance concentration in the treatment target water and the organic substance concentration in the filtered water. Therefore, in Example 1 and Example 2, after the property of the treatment target water of the membrane separation tank 1 changed, the TMP increase speed could be maintained with the membrane surface aeration flow amount smaller than that in the comparative example, whereby power-saving operation of the membrane separation device was achieved.

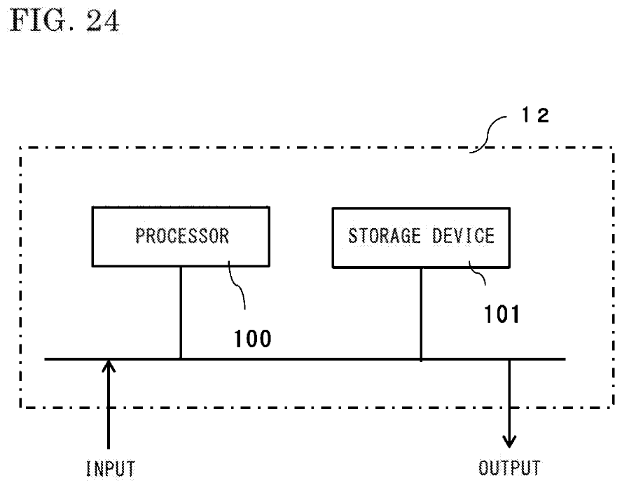

It is noted that the TMP increase speed changing means 12 is configured from a processor 100 and a storage device 101 as shown in a hardware example in FIG. 24. Although not shown, the storage device includes a volatile storage device such as a random access memory, and a nonvolatile auxiliary storage device such as a flash memory. Instead of a flash memory, a hard-disk auxiliary storage device may be provided. The processor 100 executes a program inputted from the storage device 101. In this case, the program is inputted from the auxiliary storage device via the volatile storage device to the processor 100. In addition, the processor 100 may output data of a calculation result or the like to the volatile storage device of the storage device 101, or may store the data into the auxiliary storage device via the volatile storage device.

Although the embodiments of the present invention have been described above, the present invention is not limited to the embodiments. Various design modifications may be made, and within the scope of the present invention, the embodiments may be freely combined with each other, or each of the embodiments may be modified or simplified as appropriate.

### DESCRIPTION OF THE REFERENCE CHARACTERS

1 membrane separation tank
2 separation membrane
3 filtered water pipe
4 filtration pump
5 membrane surface aeration device
6 aeration pipe
7 diffuser pipe
8 inflow water
9 treatment target water
10 treated water (filtered water)
11 bubble
12 TMP increase speed changing means
13 target TMP increase speed setting means
14 TMP increase speed measurement means
15 TMP increase speed comparing means
16 membrane surface aeration flow amount control unit
17 pressure measurement unit
18 TMP increase speed calculation unit
19 organic substance concentration measurement means
20 database
21 target TMP increase speed selecting unit
22 organic substance concentration measurement means
23 organic substance concentration difference value calculation unit
24 solid-liquid separation unit
25 organic substance concentration measurement unit
27 organic substance index measurement means
28 water temperature measurement means
29 MLSS measurement means
30 flux measurement means
31 target TMP increase speed input means

1: A membrane separation device comprising:
a separation membrane which filters treatment target water in a membrane separation tank;
a membrane surface aeration device which supplies air for performing membrane surface aeration for the separation membrane;
organic substance concentration measurement means which measures an organic substance concentration in the treatment target water;
a pressure measurement unit which measures a transmembrane pressure of the separation membrane;
transmembrane pressure increase speed comparing means which compares a transmembrane pressure increase speed R_{T} selected on the basis of a value of the organic substance concentration measured by the organic substance concentration measurement means, with a transmembrane pressure increase speed R_{M} calculated from the transmembrane pressure measured by the pressure measurement unit; and
a control unit which controls a membrane surface aeration flow amount of the membrane surface aeration device, wherein
the control unit changes the membrane surface aeration flow amount on the basis of the difference, obtained by the transmembrane pressure increase speed comparing means, between the transmembrane pressure increase speed R_{T} selected on the basis of the value of the organic substance concentration measured by the organic substance concentration measurement means and the transmembrane pressure increase speed R_{M} calculated from the transmembrane pressure measured by the pressure measurement unit.

2: The membrane separation device according to claim 1, wherein
in selection of the transmembrane pressure increase speed R_{T} on the basis of the value of the organic substance concentration measured by the organic substance concentration measurement means, the transmembrane pressure increase speed R_{T} is selected from data in which a relationship between an organic substance concentration in treatment target water and a transmembrane pressure increase speed, acquired in advance, is stored.

3: The membrane separation device according to claim 1, wherein
in calculation of the transmembrane pressure increase speed R_{M} from the transmembrane pressure measured by the pressure measurement unit, the transmembrane pressure increase speed R_{M} is calculated from temporal change in the transmembrane pressure of the separation membrane.

4: A membrane separation device comprising:
a separation membrane which filters treatment target water in a membrane separation tank;
a membrane surface aeration device which supplies air for performing membrane surface aeration for the separation membrane;
organic substance concentration measurement means which measures an organic substance concentration in the treatment target water;
a pressure measurement unit which measures a transmembrane pressure of the separation membrane;
target transmembrane pressure increase speed setting means which sets a target transmembrane pressure increase speed R_{T} on the basis of a value of the organic substance concentration in the treatment target water;
transmembrane pressure increase speed measurement means which calculates a transmembrane pressure increase speed R_{M} from the transmembrane pressure of the separation membrane;
transmembrane pressure increase speed comparing means which compares the target transmembrane pressure increase speed R_{T} from the target transmembrane pressure increase speed setting means, with the transmembrane pressure increase speed R_{M} from the transmembrane pressure increase speed measurement means; and
a control unit which controls a membrane surface aeration flow amount of the membrane surface aeration device, wherein
the control unit changes the membrane surface aeration flow amount on the basis of the difference, obtained by the transmembrane pressure increase speed comparing means, between the transmembrane pressure increase speed R_{T} selected on the basis of the value of the organic substance concentration measured in the treatment target water and the transmembrane pressure increase speed R_{M} calculated from the transmembrane pressure measured by the pressure measurement unit.

5: The membrane separation device according to claim 4, wherein
the target transmembrane pressure increase speed setting means includes: a database in which a relationship between an organic substance concentration in treatment target water and a transmembrane pressure increase speed, acquired in advance, is stored; and a target transmembrane pressure increase speed selecting unit which selects the target transmembrane pressure increase speed R_{T} on the basis of the value of the organic substance concentration measured by the organic substance concentration measurement means and data in the database.

6: The membrane separation device according to claim 4, wherein
the transmembrane pressure increase speed measurement means includes a transmembrane pressure increase speed calculation unit which calculates the transmembrane pressure increase speed R_{M} from the transmembrane pressure measured by the pressure measurement unit.

7: The membrane separation device according to claim 1, wherein
when the transmembrane pressure increase speed R_{T} selected on the basis of the value of the organic substance concentration measured by the organic substance concentration measurement means is greater than the transmembrane pressure increase speed R_{M} calculated from the transmembrane pressure measured by the pressure measurement unit, the control unit decreases the membrane surface aeration flow amount, and when the transmembrane pressure increase speed R_{T} selected on the basis of the value of the organic substance concentration measured by the organic substance concentration measurement means is smaller than the transmembrane pressure increase speed R_{M} calculated from the transmembrane pressure measured by the pressure measurement unit, the control unit increases the membrane surface aeration flow amount.

8: The membrane separation device according to claim 5, further comprising database update means which calculates a new target transmembrane pressure increase speed R_{T}′ for the organic substance concentration measured by the organic substance concentration measurement means, and updates the relationship between the organic substance concentration in the treatment target water and the transmembrane pressure increase speed, stored in the database.

9: The membrane separation device according to claim 8, wherein
the database update means includes:
membrane surface aeration flow amount comparing means which compares a membrane surface aeration flow amount Q_{M} when the transmembrane pressure increase speed R_{T} selected on the basis of the value of the organic substance concentration measured by the organic substance concentration measurement means and the transmembrane pressure increase speed R_{M} calculated from the transmembrane pressure measured by the pressure measurement unit have become equal to each other through control, with a membrane surface aeration flow amount Q_{T} corresponding to the target transmembrane pressure increase speed R_{T}, stored in the database;
target transmembrane pressure increase speed calculation means which, when the membrane surface aeration flow amount Q_{M} and the membrane surface aeration flow amount Q_{T} are different from each other in the membrane surface aeration flow amount comparing means, causes the control unit to change the membrane surface aeration flow amount, and calculates a new target transmembrane pressure increase speed R_{T}′; and
a database update unit which stores, in the database, the new target transmembrane pressure increase speed R_{T}′ calculated by the target transmembrane pressure increase speed calculation means, a membrane surface aeration flow amount Q_{T}′ corresponding thereto, and the value of the organic substance concentration measured by the organic substance concentration measurement means.

10: The membrane separation device according to claim 9, wherein
the target transmembrane pressure increase speed calculation means includes: a membrane surface aeration flow amount change command unit which sends a signal to the control unit so as to change the membrane surface aeration flow amount; and a target transmembrane pressure increase speed calculation unit which calculates the new target transmembrane pressure increase speed R_{T}′ on the basis of a relationship between the membrane surface aeration flow amount when the membrane surface aeration flow amount has been changed by the control unit in accordance with a command sent from the membrane surface aeration flow amount change command unit, and the transmembrane pressure increase speed at that time.

11: The membrane separation device according to claim 10,
wherein the membrane surface aeration flow amount change command unit sends a command to the control unit so as to decrease the membrane surface aeration flow amount when the membrane surface aeration flow amount Q_{M} is greater than the membrane surface aeration flow amount Q_{T} and so as to increase the membrane surface aeration flow amount when the membrane surface aeration flow amount Q_{M} is smaller than the membrane surface aeration flow amount Q_{T}, and
the target transmembrane pressure increase speed calculation unit calculates the new target transmembrane pressure increase speed R_{T}′ on the basis of a relationship between the membrane surface aeration flow amount and the transmembrane pressure increase speed corresponding thereto when the membrane surface aeration flow amount has been changed from Q_{M} to Q_{T}.

12: A membrane separation device comprising:
a separation membrane which filters treatment target water in a membrane separation tank;
a membrane surface aeration device which supplies air for performing membrane surface aeration for the separation membrane;
first organic substance concentration measurement means which measures an organic substance concentration in the treatment target water;
second organic substance concentration measurement means which measures an organic substance concentration in filtered water filtered by the separation membrane;
a pressure measurement unit which measures a transmembrane pressure of the separation membrane;
transmembrane pressure increase speed comparing means which compares a transmembrane pressure increase speed R_{T} selected on the basis of an organic substance concentration difference obtained by subtracting a value of the organic substance concentration measured by the second organic substance concentration measurement means from a value of the organic substance concentration measured by the first organic substance concentration measurement means, with a transmembrane pressure increase speed R_{M} calculated from the transmembrane pressure measured by the pressure measurement unit; and
a control unit which controls a membrane surface aeration flow amount of the membrane surface aeration device, wherein
the control unit changes the membrane surface aeration flow amount on the basis of the difference, obtained by the transmembrane pressure increase speed comparing means, between the transmembrane pressure increase speed R_{T} selected on the basis of the value of the organic substance concentration measured by the organic substance concentration measurement means and the transmembrane pressure increase speed R_{M} calculated from the transmembrane pressure measured by the pressure measurement unit.

13: The membrane separation device according to claim 1, wherein
in measurement for the organic substance concentration, the treatment target water in the membrane separation tank is subjected to solid-liquid separation by any of filtration separation, centrifugal separation, and precipitation separation, and an organic substance concentration in liquid obtained by the solid-liquid separation is measured.

14: The membrane separation device according to claim 1, wherein
for the organic substance concentration, at least one of an ultraviolet absorbance, a total organic carbon concentration, a biochemical oxygen demand, a chemical oxygen demand, a humic acid concentration, a sugar concentration, and a protein concentration, is measured.

15: The membrane separation device according to claim 1, wherein
in selection of the transmembrane pressure increase speed R_{T} on the basis of the organic substance concentration, the transmembrane pressure increase speed R_{T} is selected by using at least one of a water temperature of the treatment target water, a suspended solid concentration in the treatment target water, and a filtration flux of the separation membrane.

16: A membrane separation method comprising:
filtering a treatment target water in a membrane separation tank by a separation membrane;
measuring an organic substance concentration in the treatment target water when performing membrane surface aeration for supplying bubbles by a diffuser pipe from below the separation membrane;
selecting a transmembrane pressure increase speed R_{T} as a target on the basis of a measured value of the organic substance concentration;
comparing the transmembrane pressure increase speed R_{T} with an increase speed R_{M} of a transmembrane pressure of the separation membrane; and
setting a flow amount of the membrane surface aeration so that a difference between the transmembrane pressure increase speed R_{T} and the increase speed R_{M} becomes small.

17: The membrane separation device according to claim 2, wherein
in calculation of the transmembrane pressure increase speed R_{M} from the transmembrane pressure measured by the pressure measuring device, the transmembrane pressure increase speed R_{M} is calculated from temporal change in the transmembrane pressure of the separation membrane.

18: The membrane separation device according to claim 5, wherein
the transmembrane pressure increase speed measure includes a transmembrane pressure increase speed calculator to calculate the transmembrane pressure increase speed R_{M} from the transmembrane pressure measured by the pressure measuring device.

19: The membrane separation device according to claim 2, wherein
when the transmembrane pressure increase speed R_{T} selected on the basis of the value of the organic substance concentration measured by the organic substance concentration measuring device is greater than the transmembrane pressure increase speed R_{M} calculated from the transmembrane pressure measured by the pressure measuring device, the controller decreases the membrane surface aeration flow amount, and when the transmembrane pressure increase speed R_{T} selected on the basis of the value of the organic substance concentration measured by the organic substance concentration measuring device is smaller than the transmembrane pressure increase speed R_{M} calculated from the transmembrane pressure measured by the pressure measuring device, the controller increases the membrane surface aeration flow amount.

20: The membrane separation device according to claim 3, wherein
when the transmembrane pressure increase speed R_{T} selected on the basis of the value of the organic substance concentration measured by the organic substance concentration measuring device is greater than the transmembrane pressure increase speed R_{M} calculated from the transmembrane pressure measured by the pressure measuring device, the controller decreases the membrane surface aeration flow amount, and when the transmembrane pressure increase speed R_{T} selected on the basis of the value of the organic substance concentration measured by the organic substance concentration measuring device is smaller than the transmembrane pressure increase speed R_{M} calculated from the transmembrane pressure measured by the pressure measuring device, the controller increases the membrane surface aeration flow amount.
